(19) United States
(12) Patent Application Publication
(10) Pub. No.: US 2011/0047039 A1
(43) Pub. Date: Feb. 24, 2011

(54) METHOD AND SYSTEM FOR GIVING A GIFT

(76) Inventors: Michelle Melinda Crames, Los Angeles, CA (US); Tim Millen, Walnut Creek, CA (US); Diane Reichenberger, Los Angeles, CA (US); Michael Slaby, Evanston, IL (US); William Dustin Young, Denver, CO (US)

Correspondence Address: SQUIRE, SANDERS & DEMPSEY L.L.P., 275 BATTERY STREET, SUITE 2600, SAN FRANCISCO, CA, 94111-3356, US

(21) Appl. No.: 12/848,958

(22) Filed: Aug. 2, 2010

Related U.S. Application Data
(60) Provisional application No. 61/230,513, filed on Jul. 31, 2009.
(60) Provisional application No. 61/230,515, filed on Jul. 31, 2009.
(60) Provisional application No. 61/230,516, filed on Jul. 31, 2009.
(60) Provisional application No. 61/230,523, filed on Jul. 31, 2009.
(60) Provisional application No. 61/330,857, filed on May 3, 2010.
(60) Provisional application No. 61/330,858, filed on May 3, 2010.
(60) Provisional application No. 61/330,859, filed on May 3, 2010.

(51) Int. Cl. G06Q 30/00; G06Q 20/00

(52) U.S. Cl. 705/18; 705/27.2

(57) ABSTRACT

A first person can give a gift by using a mobile phone or other communications device to access a central computing system to which a gift and a second person (the intended recipient of the gift) can be identified by the first person. Thereafter, the central computing system transmits a unique code to the mobile phone or other communications device of the second person. The code can then be given by the second person, verbally or by transmission or display by his/her mobile phone, to a retailer of the gift. Upon validation by the retailer, such as by communication between the retailer's point-of-sale system and the central computing system, the retailer provides the gift identified by the first person.

### CROSS-REFERENCE TO RELATED APPLICATIONS

This application claims the benefit of U.S. Provisional Application No. 61/230,513, filed Jul. 31, 2009, No. 61/230,515, filed Jul. 31, 2009, No. 61/230,516, filed Jul. 31, 2009, No. 61/230,523, filed Jul. 31, 2009, No. 61/330,857, filed May 3, 2010, No. 61/330,858, filed May 3, 2010, and 61/330,859, filed May 3, 2010, all of which are incorporated herein by reference.

### FIELD OF THE INVENTION

This invention relates generally to electronic communications, more particularly, to a method and system of giving a gift through the use of a code redeemable for the gift.

### BACKGROUND OF THE INVENTION

At present, the ability for consumers to leverage mobile communications devices to deliver and receive content other than basic communication and graphics is limited. This is especially true for the delivery of gifts through a mobile communications device. For example, consumers may receive notice of a discount at a specific product at a specific retailer; but they are not able to receive data that is associated with and can be redeemed for a specific item at a physical or virtual retail location. Additionally, consumers may receive a digital code, such as a gift card ID, which may be associated with a denominated dollar value; but they are not able to receive an ID that is redeemable for only a specific item, or which is linked to a specific item and funded in an amount specific to cover the cost of that item. What is needed is a solution to this existing challenge, such as by providing a system and process by which consumers may send and receive information that may be redeemed only for a specific gift or service, as opposed to a generic coupon or denominated dollar that is not limited for use on a specific gift or service.

### SUMMARY OF THE INVENTION

Briefly and in general terms, the present invention is directed to a method and system for giving a gift of a specific product or service. In aspects of the present invention, a method comprises causing display of potential gifts on a first electronic communications device of a party giving a gift, the first electronic communications device configured for wireless communication. The method further comprises receiving from the first electronic communications device information that identifies a gift selected from the potential gifts. The method further comprises receiving from the first electronic communications device information that identifies a recipient, the recipient being a person to receive the selected gift. The method further comprises receiving from the first electronic communications device information that defines parameters for message delivery to a second electronic communications device of the recipient. The method further comprises sending a message containing a code to the second electronic communications device, the sending performed using the parameters for message delivery, the code uniquely associated with the selected gift, the code redeemable for only the selected gift, the code formatted to be recognized and processed by a specific retailer of the selected gift.

In other aspects of the present invention, a method comprises receiving information identifying a gift and identifying a recipient, the recipient being a person to receive the gift, the information being received from a first electronic communications device of a party giving the gift. The method further comprises, sending a code to a second electronic communications device of the recipient. The code is uniquely associated with the gift. The code is redeemable for only the gift at a specific retailer of the gift. The code is formatted to be recognized and processed by the specific retailer. The sending is performed by a computer system in response the information received from the first electronic communications device.

In other aspects of the present invention, a system comprises a computer system in communication with an electronic communications device and a second electronic communications device. The computer system receives from the first electronic communications device gift information identifying a specific gift and recipient information identifying a person to receive the specific gift. The computer system comprises a database system that uses the gift information to generate or retrieve a code uniquely associated with the specific gift, a retailer management system that customizes format of the code for a specific retailer of the specific gift, and a user management system that uses the recipient information to send the formatted code to the second electronic communications device. The computer system uniquely associates the code with the specific gift from the specific retailer in such a way to prevent the code from being redeemed at a retailer different from the specific retailer and to prevent the code from being redeemed for a product or service different from the specific gift.

The features and advantages of the invention will be more readily understood from the following detailed description which should be read in conjunction with the accompanying drawings.

### BRIEF DESCRIPTION OF THE DRAWINGS

FIG. 1 is a block diagram of a system for giving a gift and redeeming the gift.

FIG. 2 is a block diagram of a system for giving a gift, showing communications devices and a retailer in communication with a computerized system for gift giving.

FIG. 3 is a block diagram of a system for redeeming a gift, showing communications devices and a retailer point-of-sale system in communication with a central processing system for gift giving.

FIGS. 4-22 are screen shots of images displayed on communications devices at various steps in a method of giving a gift.

FIGS. 23-31 are screen shots of images displayed on communications devices at various steps in a method of giving a gift.

FIG. 32 is a flow diagram of a corporate rewards program.

FIGS. 33-41 are screen shots of images displayed on communications devices at various steps in a method of giving a gift according to FIG. 32.

### DETAILED DESCRIPTION OF THE PREFERRED EMBODIMENTS

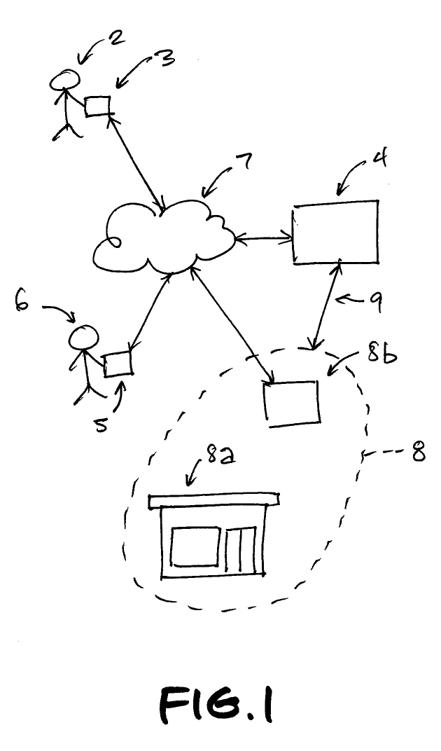

As shown in FIG. 1, a sender 2 of the gift does not physically hand the gift to the recipient. Instead, the sender 2 selects the gift on a computerized system 4. The sender also selects the intended recipient 6 of the gift and the retailer 8 of the gift on the computerized system 4. The selection is made via an electronic device 3, such as a mobile telephone, operated by the sender. In response to the selection, the computerized system 4 generates and transmits a code uniquely associated with the selected gift. The code is transmitted to another electronic device 5, such as another mobile telephone, operated by the recipient 6. Electronic communication between the electronic devices and the computerized system 4 is handled by a communications network 7 that may comprise a local area network (LAN), wide area network (WAN), portions of the Internet and/or wireless communication carriers.

Next, the code is used by recipient 6 to redeem or obtain the selected gift from the retailer 8, either by personally visiting a “brick and mortar” physical store 8a or by accessing the retailer's Internet website hosted on a remote server 8b, by using his or her electronic device 5 or by calling a phone number to arrange delivery. The recipient 6 can receive the actual gift item or gift service from the physical store 8a. The Internet website functions as a virtual store from which the gift can be ordered by the recipient for delivery to the recipient.

It is to be understood that the selected gift service or item is not performed for or shipped to the recipient 6 at a time before or immediately upon the recipient's receipt of the code from the computer system 4. Before the recipient 6 can get the selected gift, the recipient must first present the code to the retailer 8.

In some embodiments, the retailer 8 does not have knowledge of or information about the gift transaction initiated by the sender 2 before the recipient 6 presents the code to the retailer. As such, before the recipient presents the code to the retailer 8, the retailer of the selected gift may not know one or any combination of: the identity of the recipient, the postal address or location of the recipient, the identity of the selected gift, and the identity the sender.

In some embodiments, the retailer 8 does not take any affirmative step to provide the gift to the recipient before the recipient resents the code to the retailer. Non-limiting examples of an affirmative step include moving or shipping the selected gift item to the recipient, and performing the selected gift service for the benefit of the recipient.

It will be appreciated that the system and method allows the recipient to determine when, where, and how he or she receives the selected gift. The recipient can receive the gift in any manner most convenient to the recipient. For example, where the selected gift is a cup of coffee at a specific retail chain of cafes, the recipient to obtain the cup of coffee at any location and at any time by using the code. The code can be stored on the recipient's own mobile telephone for convenient access when needed by the recipient.

In some embodiments, the sender 2 does not provide the recipient's postal address to the computer system 7 or the retailer 8 at any time before the recipient 6 receives the code from the computer system 4. In some embodiments, the sender 2 does not provide the recipient's postal address to the computer system 7 or the retailer 8 at any time before the recipient 6 presents the code to the retailer 8 or before the recipient 6 obtains the gift.

It will be appreciated that the system and method allows the sender to give a gift with just the recipients mobile phone number and without knowing other details about the recipient, such as the recipients schedule, location, postal address, and true name. The system and method allows the sender, in some embodiments, to save money by not having to pay a fee for shipping the gift to the recipient. Also, through use of the code, the sender can give a type of gift (e.g., a fresh cup of coffee or perishable food item) that would normally be given in person due to difficulties or expense of shipping that type of gift.

In alternative embodiments, the code is not presented to the recipient 6. Direct back-end transmission 9 between the computerized system 4 and a point-of-sale system at the physical store or Internet website of the retailer 8 allows the recipient 6 to obtain the gift.

The selected gift can be a product or service offered by one or more retailers. Examples of gifts that can be selected include “real” gifts associated with, but not limited to, a tangible item, such as: books, food items, consumer products, and other physical good; a service such as a spa treatment; and a virtual item, such as an electronic movie ticket, digital song or gaming content. Other examples of gifts that can be selected may also be associated with an intangible item, such as monetary credit and gift points redeemable at a particular retailer or group of retailers. The retailer can have a physical “brick and mortar” retail store that can be visited by the intended recipient to obtain the gift. The retailer can be an online retailer operating a web site on the Internet which functions as a virtual store from which the gift can be ordered by the intended gift recipient.

The terms “retailer,” “providers,” “suppliers,” “sellers” and “merchants” are used interchangeably herein, and refers to a person or other entity that provides the gift to the recipient or from which the recipient may obtain the gift.

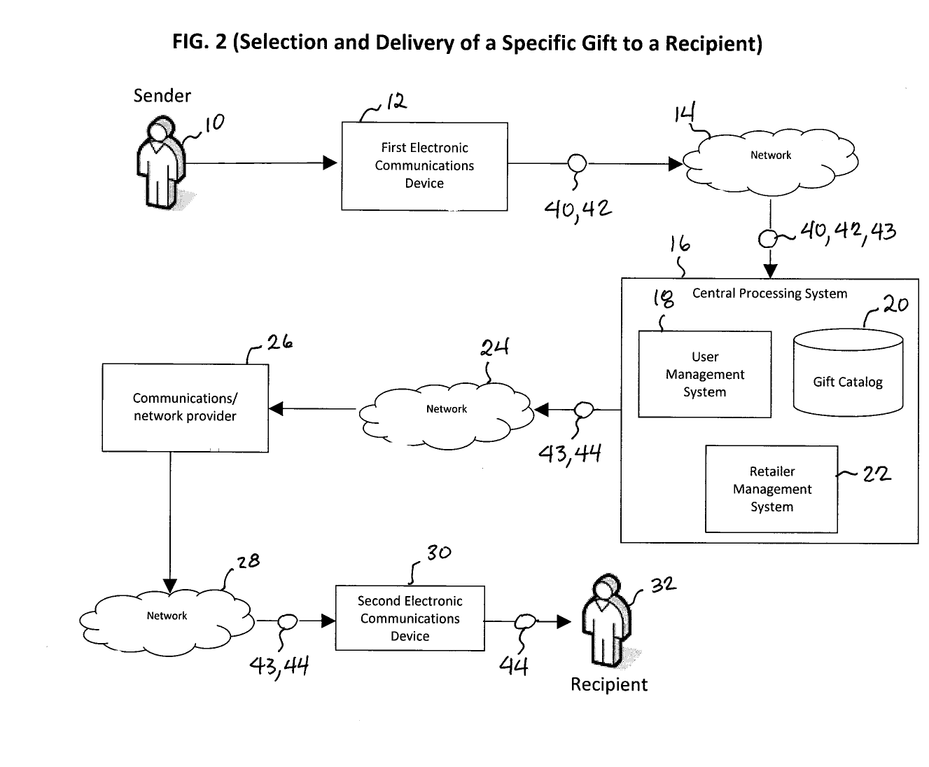

FIG. 2 shows a system and method for selecting and giving a specific gift to a recipient in accordance with embodiments of the invention. A person, referred to as the sender 10, uses a first electronic communications device 12 to communicate through a communications network 14 to access a central processing system 16. The communications network 14 can be a wireless network, which can include a local area network (LAN), wide area network (WAN), portions of the Internet and/or wireless communication carrier. The central processing system 16 includes electronic memory stores, logic, and electronic processors running software that enable the sender 10 to select a gift to be given. The central processing system includes a user management system 18, a retailer management system 22, and a gift catalog 20.

The user management system 18 comprises a data storage device which contains user information specific to an individual recipient such as the type of their electronic communications device and their contact information. User information also includes data on the payment account owned by the sender and profile information such as frequently given gifts, frequent recipients and default messaging options. The payment account can be a credit or debit vehicle, a stored-value or prepaid account, a PayPal® account or other account that enables the online purchase of items.

The retailer management system 22 comprises a data storage device that contains retailer information. The retailer information comprises information on many retailers of the various gifts that are available for selection. For each particular retailer, the retailer information includes data required to redeem the gift. Such data dictates digital format and messaging that is used to package the virtual delivery of the gift.

The gift catalog 20 contains a collection of specific gifts that can be selected and a library of codes that will be or already have been uniquely associated with a specific gift item or service and formatted such that they can be processed by a specific retailer.

In some embodiments, a code from the library is assigned by the central processing system 16 to a gift transaction defined by the particular gift, merchant and recipient that have been selected by the sender 10. The assignment occurs or performed after the gift transaction is defined. The code is unique to the gift and to the specific transaction, which enables the central processing system to track not only the gift, but the sender, recipient, retailer, and other aspects of the gift transaction.

In alternative embodiments, a particular gift available from a particular retailer already has a code preassigned to it, and that preassigned code is taken from the library for use by the central processing system. The preassignment occurs or was performed before the gift transaction was initiated by the sender. The code may be associated only with the particular gift, and a separate data element will be appended to form a larger code that is unique to the gift transaction initiated by the sender. This separate data element that is appended to the gift code may include the recipient's or sender's mobile telephone number, or a unique code that generated by or retrieved from the gift catalog 20 and used by the central processing system 16.

After a gift has been selected by the sender 10 and a monetary cost of the gift has been charged against an account owned by the sender, the central processing system 16 generates, selects, obtains, and/or assigns a code for the selected gift, then transmits the code through a communications network 24 to a communications/network provider 26. The communications/network provider 26 can be, for example and not limitation, a major wireless carrier such as Verizon® or AT&T®, an Internet provider such as a cable company, or other entity that controls the dissemination of digital information. The communications network 24 can be a wireless network which can be distinct and separate from, the same as, or overlap with communications network 14. The communications network 24 can also include a local area network (LAN), wide area network (WAN), portions of the Internet and/or wireless communication carriers. The information about gift may also be received by the recipient 32 by e-mail account or via delivery a social network account (such as Facebook® or twitter™). If delivered to an e-mail account or a social network, the recipient 32 may or may not have to enter his or her phone number to retrieve the gift item or service.

Still referring to FIG. 2, the communications/network provider 26 transmits the code through a communications network 28 to a second electronic communications device 30 operated by another person 32 who is the intended recipient of the gift. The communications network 28 can be a wireless network which can be distinct and separate from, the same as, or overlap with communications network 14 and/or communications network 24. The communications network 28 can also include a local area network (LAN), wide area network (WAN), portions of the Internet and/or wireless communication carriers. The code can be viewed by the recipient 32 on the second electronic communications device. The rendering of the viewed code is configured specifically to the technical specifications of the recipient's communication device and to the technical specifications of the merchant of the gift. The code can be numeric, alphabetic, alphanumeric and/or graphic, such as a bar code or other optically readable and machine readable image. In some embodiments, the code is not presented to the recipient 32 and is either wirelessly transferred to the merchant or retrieved later by the recipient during the redemption process.

To obtain the selected gift item or service, the recipient 32 communicates the code to the merchant, which can be done verbally at the merchant's retail store, by manually entering the code into the merchant's point-of-sale system at a physical or online store location, by wireless transmission between the recipient's communication device 30 and the retailer's point-of-sale system, or via direct back-end transmission between the central processing system 16 and the retailer point-of-sale system. Thereafter, the recipient 32 receives the gift selected by the sender 10. The various processes for obtaining the gift, also referred to as “redeeming,” are described below.

A method of giving a gift of a specific product or service will be described below. Although the method will be described with reference to elements of FIG. 2, it will be appreciated that other systems and devices could be used to implement the method. The method comprises displaying a plurality of potential gifts on a first electronic device 12 operated by a person 10 giving a gift. The first electronic device 12 is configured for wireless communication and to send and receive digital or radio frequency signals. The displaying can include showing a menu or list of the potential gifts on the first electronic device 12, non-limiting examples of which include a mobile telephone, laptop computer, personal digital assistant, computerized tablet, and desktop computer. The displayed list can include any one or a combination of the following types of information: text descriptions of the potential gifts, images of the potential gifts, monetary cost of the potential gifts, and identification of retailers of the potential gifts. The list and any of the preceding types of information can be provided to the first electronic communications device 12 by a central processing system 16 discussed below. The list can be provided by the central processing system 16 and displayed in response to a search command from the first electronic communications device 12. The search command can be in the form of a search string having the format “SEARCH [search_term] to [shortcode]” or other format recognized by the central processing system 16. In the search string, [search term] is text that describes the type of gift the sender 10 wishes to give, for example “book,” “coffee,” or “spa treatment”.

Alternatively or in combination with the displayed list described above, the plurality of potential gifts can be displayed on the first electronic communications device 12 when the person 10 giving the gift uses the device 12 to access a website of a retailer of the gift. The website can be a retail website accessible through the Internet.

In a next step, the method comprises receiving from the first electronic device 12 various information. The received information includes information 40 that identifies a gift selected by the sender 10 from the displayed list and information 42 that identifies the person 32 to receive the gift. The information 40, 42 can be received through a network 14 by the central processing system 16. The information 40, 42 can be in the form of a message string sent from the first electronic communications device 12, the message string having the format “GIVE [productID] to [recipientID] via [digital_identifier]” or other format recognized by the central processing system 16. In the message string, [productID] is text information 40 that identifies the gift, [recipientID] is text information 42 that identifies the recipient 32 of the gift, and [digital_identifier] is text information that can further identify the recipient 32 and enables subsequent communications routing to that recipient.

The information 40 that identifies the recipient 32 can include any one or a combination of the name of the recipient 32 and contact information of the recipient 32. Contact information includes, without limitation, a telephone number, e-mail address, and/or social networking profile of the recipient 32. The information 40 that identifies the recipient 32 can include a digital identifier to route the selected gift to the recipient 32 over the electronic networks 24, 28. Examples of a digital identifier include without limitation a wireless telephone number, an e-mail address, an account on a social networking site, a server address, and any combination thereof. The received information can also include without limitation personalized information from the sender that would otherwise not be stored within the central processing system. This personalized information could include a message to be sent to the recipient such as “happy birthday” or “congratulations.”

Alternatively or in combination with the process described above, the information 40, 42 that identifies the selected gift and the person 32 receiving the selected gift can be generated through a website of a retailer of the gift. The website can be a retail website accessible through the Internet. The person 10 giving the gift can access the website using the first electronic communications device 12 and use the website to select and/or identify the gift and/or the person 32 to receive the gift. Next, the central processing system 16 receives the information 40, 42 from the website.

In a next step, the method comprises sending a code 44 to a second electronic communications device 30 operated by the person 32 to receive the gift. The code 44 can be generated and sent by the central processing system 16 in response to receipt of information 40, 42 from the first electronic communications device 12. The code 44 is uniquely associated with the gift transaction defined at least in part by the identity of the selected gift, identity of the person 10 giving the gift and identity of the person 32 to receive the gift. In this context, “uniquely associated” means that that the code is unique to the gift transaction involving the particular gift giver 10, gift recipient 32, and particular gift that was selected. For example, a particular code is sent when John (gift giver 10) selects a first book title to give to Jane (gift recipient 32). For another gift transaction, a different code is sent when John selects a second book title to give to Jane. For yet another gift transaction, a different code is sent when John selects the second book title to give to Mary (a different gift recipient). For still another gift transaction, a different code is sent when John selects the second book title to give to Mary for a second time. In yet another gift transaction, a different code is sent when Mark (a different gift giver) selects the second book title to give to Mary.

The code 40 that is sent to the gift recipient 32 is redeemable for only the gift that was selected by the person 10 giving the gift. In the immediately preceding example above, Mary can use the code 40 to redeem or receive from a retail merchant only the particular book title selected by Mark, and no other book title.

The second electronic communications device 30 can be the same or different type of device as the first electronic communications device 12. Both the first and second electronic communications devices can be operatively connected, including wireless communication connection, to data networks. Data networks include infrastructure that enables the broad dissemination of digital information such as wireless networks, physical wired networks or a combination thereof.

The code 40 is formatted to be recognized and processed by a specific retailer of the gift. Such formatting considers the font of numeric or alphanumeric codes, the type of graphic such as a bar code, the size of a graphic image, and/or other information that tailors the data to a specific retailer. In this context, “specific retailer” means that a different retailer of the same gift may not recognize and/or process the code. In the immediately preceding example above, Mary can use the code 40 to redeem or receive Mark's selected book title only from a specific retailer, not from another retailer of the same book title. The specific retailer can be the one that was identified with the book title on the list of potential gifts that was displayed on the first electronic device 12. For instance, the specific retailer can be a particular retail chain comprising multiple store locations from which Mary can obtain Mark's selected book title.

The information about the gift transaction received by the central processing system 16 from the first electronic communications device 12 can also include a greeting or personal message 43 from the person 10 giving the gift to the person 32 to receive the gift. The central processing system 16 can send the personal message 43 with the code 44 to the second electronic device 30. The personal message 43 can include text, images, and combinations thereof.

The code 40 and personal message 43 can be communicated through a wireless carrier to the second electronic communications device 30 as a message via Short Message Service (referred to as “SMS”) or via Multimedia Messaging Service (referred to as “MMS”). The communications/network provider 26 can be the wireless carrier.

The receipt by the central processing system 16 of information about the gift transaction occurs after the following steps: (1) receipt by the central processing system 16 of the previously described search string through the wireless carrier; and (2) communicating through the wireless carrier information about the plurality of gifts to the first communications device.

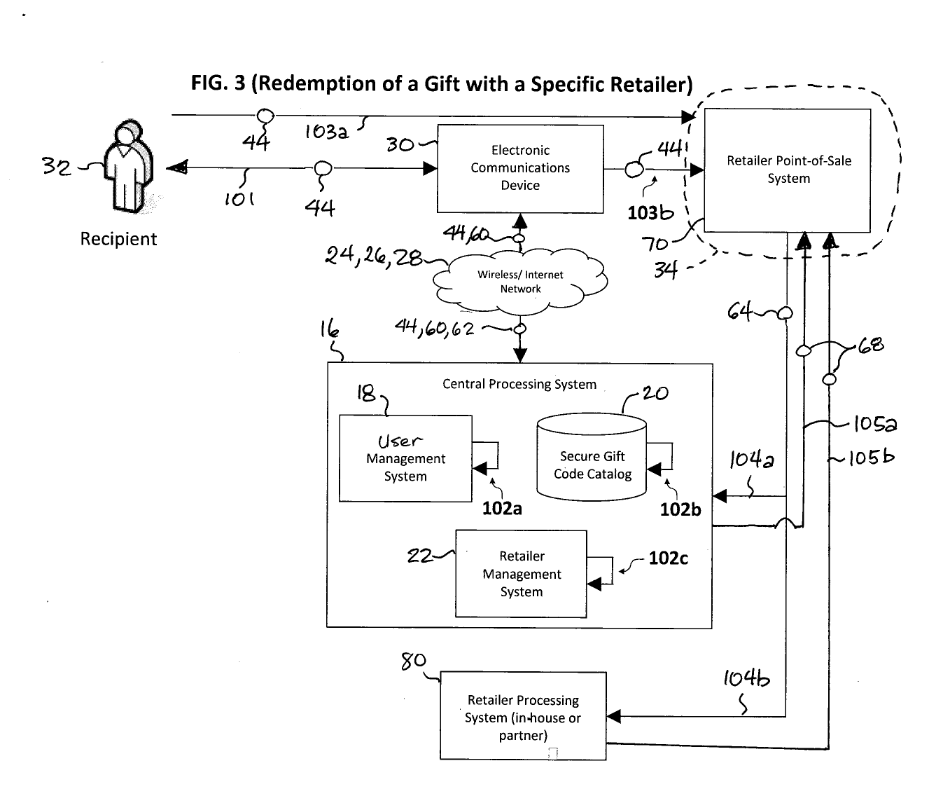

FIG. 3 shows a method of redeeming a specific gift, which has been given to the recipient via an electronic communications device, with a retailer. Arrow 101 shows the interaction between the recipient 32 and the electronic communications device 30 such that the consumer may retrieve the code, which is uniquely associated with the specific gift and formatted for a specific retailer 34. The recipient 32 can be any individual person who has received a code that can be redeemed for a specific gift. The electronic communications device 32 (also shown in FIG. 1 as the “second electronic communications device”) could be a mobile phone, a wireless computer, or any other communication device that is capable of storing the code in digital form and that may be used by the recipient 32. The interaction may include without limitation: manual entry of information into the electronic communications device 30 by manipulation of keys on the device 30, viewing text and images on the device 30, speaking into the device 30, and hearing words and other sounds from the device 30. Interaction between the recipient 32 and the electronic communications device 30 may include the use of a software application that resides in electronic processors and memory devices of the electronic communications device 30. Alternatively or in combination with the software application residing in the electronic communications device 30, interaction between the recipient 32 and the device 30 may depend on a software application that is hosted remotely and accessed through a network connection. For example, the electronic communications device 30 may access digital content from the central processing system 16 for display on the device 30, or the digital content may be provided to the electronic communications device 30 by the user management system 18 that provides customer profile information displayed on the handset. Specific interaction with the software application will be governed by the type and functionality of the particular communications device 30, and may include use of a keyboard, touch-screen, trackball, voice commands, or other method of input.

Arrow 102 shows 2-way communication between the electronic communications device 30 and the central processing system 16 via a wireless or Internet network 28 to retrieve information required to complete a redemption process at a retail location of a predetermined retailer of the gift. The terms “predetermined retailer” and “specific retailer” are interchangeable and refer to a retailer or group of retailers from which the recipient 32 must obtain the gift and may be a retailer or group of retailers specified by the sender during the gift selection process. Briefly, the redemption process includes use of the code 44 by the recipient 32 to obtain or redeem from the retail location the gift selected by the sender 10. The selection process may optionally be as described above in connection with FIGS. 1 and 2.

In some embodiments, the redemption process includes retrieval of the code 44 that is uniquely associated with the gift, and retrieval of information 60 that dictates how the code 44 is to be handled by the electronic communications device 30 so that it can be processed by the specific retailer. For example, the specific retailer may require the code 44 to be a 1-dimensional barcode, so the retrieved information 60 will dictate that the electronic communications device 30 display or format the code 44 in the form of a graphic or image of a 1-dimensional barcode. The specific retailer may alternatively require the code 44 to be a 2-dimensional barcode, radiofrequency transmission (e.g., radiofrequency identification (“RFID”) and Near Field Communication (“NFC”)), or other communication format, then the electronic communications device 30 will render, format and/or transmit the code 44 accordingly based on the retrieved information 60. It will thus be appreciated that the code 44 can be customized for the particular capabilities or requirements of the recipient's communications device 30 and/or the retailer's POS system 70.

Still referring to FIG. 3 multiple systems within the central processing system 16 are leveraged (i.e., used and operated) such as: the user management system 18, which contains information specific to an individual recipient such as the type of their electronic communications device and their contact information; the retailer management system 22, which contains information specific to the retailer such as the data and information required to redeem the gift; and the secure gift code catalog 20 (also referred to as “Gift Catalog” in FIG. 2), which contains a library of codes which can be or are already uniquely associated with a specific gift item and formatted such that they can be processed by a specific retailer.

As mentioned above, the codes in the gift ID database 20 are uniquely associated with a specific gift item. In some embodiments, the term “uniquely associated” means that the same code is used when two different people give the same gift to different people; in which case, the code in the database 20 could be appended later with an identifier, the identifier being unique to the recipient 32 or unique to the gift transaction between the particular sender and recipient. The identifier appended to the code can be, for example and not limitation, the recipient's telephone number or other data. In alternative embodiments, the term “uniquely associated” means that a particular code is retrieved from the database 20 and assigned or associated for the selected gift and the gift transaction between the particular sender and recipient; in which case, the particular code cannot be assigned or associated with another gift selection or gift transaction.

In some embodiments, the recipient 32 may be required to provide authentication information 62 to the central processing system 16 in order to retrieve or activate the code 44 uniquely associated with the specific gift. The potential processing of information from within these identified sub-systems as part of set 102, are represented by separate, potential steps 102a, 102b, and 102c.

In some embodiments, the code 44 is automatically sent to the recipient 32 upon selection of and/or payment for the gift by the sender 10.

In alternative embodiments, the recipient 32 must first request the code 44 be provided to the electronic communications device 30. When the code 44 is provided, the recipient 32 is alerted that such code is valid only for a predetermined time interval (e.g., 15 minutes). In particular, the code 44 is retrieved from the secure gift code database 20, formatted and delivered by the central processing system 16 to the electronic communications device 30 in the manner required by the recipient 32 and retailer. The required manner of formatting and delivery is specified within the user management system 18 and the retailer management system 22, as represented by separate, potential steps 102a, 102b, and 102c. For example, Bob 10 sends Mary 32 a gift, and Mary is alerted of this gift on her electronic communications device 30. Mary may see a personalized message from Bob, information about the gift, and other details, but she does not see a specific gift code 44 uniquely associated with the gift. Mary retrieves the specific gift code 44 for redemption only when she visits a physical or virtual retail location to redeem the gift item. The term “virtual” refers to an electronic or digital presence or location, such as a retail website accessible on the Internet. To retrieve the code, she sends a message from her electronic communications device 30 to the central processing system 16, such message being any of an e-mail, text message, phone call, and selection or “clicking” of a hyperlink to a website page.

In some embodiments, as shown by arrow 103, the recipient 32 provides the code 44 to a point-of-sale (POS) system 70 of the retailer 34. The recipient 32 may provide the code 44 directly to the POS system 70, as indicated by arrow 103a, by verbally reading the code 44 to a person at a physical store of the retailer 34, by entering the code into an order form on a retail website page of the retailer 34, or by other methods. Alternatively, as indicated by arrow 103b, the recipient 32 may use the electronic communications device 30 to provide the code 44 digitally stored in the device 30 to the POS system 70. The process by which the recipient 32 provides the code 44 to the POS system 70 is tailored to both requirements and/or capabilities of the electronic communications device 30 and the specific retailer 34, which may include variations on how the code is rendered or sent by the electronics communications device 70—such as a graphic, number, wireless transmission—and how the code is input into the retail POS system 70. For example, where the code 44 is required to be a machine readable 2-dimension bar code, the electronic communications device 30 will render or display the code 44 as a 2-dimensional bar code to allow it be read or scanned by a barcode reader that is part of the POS system 70. Once the code is input into the retailer's POS system it is processed via the method that is appropriate to that retailer. For example, the retailer 34 may send data 64 to the central processing system 16 for confirmation, or the retailer may send the data to a retailer processing system 80 that processes payment transactions for the retailer. The data 64 that is sent may include the code 44. The retailer processing system 80 is a computerized system operated by the retailer 34 or by an existing partner of the retailer that processes payment transactions for the retailer. Whether the data 64 is sent to the central processing system 16 or the retailer processing system 80, a confirmation will be returned to the retailer 34 to allow retailer to know that the code is valid. Thereafter, the retailer 34 provides the gift to the recipient 8 if and only if the code 44 is valid.

In some embodiments, the retail POS system 70 directly communicates the code 44 (received from the electronic communications device 30 or recipient 32) to the central processing system 16, as depicted by arrow 104a. For example, in the case that the code 44 was generated by or retrieved from within the central processing system 16, the retail POS system 70 sends a query 64 to the central processing system to confirm that the code is valid. Alternatively, if the code 44 was generated by a system within the retailer or an existing partner of the retailer (so that the code 44 was generated by the central processing system 16), the retail POS system 70 sends a query 64 to the in-house or partner system 80 to confirm that the code is valid, as depicted by arrow 104b. In either scenario, a confirmation 68 is sent in reply to the POS system 70, as indicated by arrows 105a, 105b. The confirmation 68 indicates that the code 44 is valid. After receipt of the confirmation by the POS system 70, the POS system 70 signals to the retail person or website that the given code 44 is valid, which prompts the retail person or website to allow the recipient 32 to complete the transaction and receive the gift.

After validation of the code 44 and the recipient 32 receives the gift item or service, the POS system 70 can send a signal to the central processing system 20 or retailer processing system 80, either of which may then deactivate or invalidate the code 44 to prevent the same code 44 from being redeemed for a gift again.

It will be appreciated the above described methods and computerized systems can be used by a person (for example, sender 2 and sender 10) who wants to give a real gift (e.g. a cup of coffee) to a friend (for example, recipient 6 and recipient 32). The person sending the gift (hereafter “sender”) visits a website or communicates with a computerized system (for example, system 4 and system 16) directly via an SMS shortcode, then navigates a gift catalog (for example, gift catalog 20 of the system 16, and a catalog database accessed through a retailer website) to find the gift the sender wishes to give. The website will display individual products grouped in any number of ways (by type, retailer, price) into a catalog that presents pages of multiple products that can be purchased by entering the recipient's cell phone number into a field then pressing a “buy” button. At that time the system will ask the sender which of three possible payment methods the sender would like to utilize. At this point, the sender purchases the gift via one of several possible methods by clicking a button of their choice.

A first purchase and payment method includes creating an account and funding it with money from a credit or debit card then using those funds to purchase the item, the sender's account being debited for the cost of the gift. In order to fund the sender's account, the sender would enter his or her credit card and billing information into fields on the website then enter the number of dollars (or other monetary quantity) that is to be transferred to the account. At that point the website charges the credit card via a standard online credit card processing vendor, and the sender would have the selected monetary amount available to give gifts via the system. The sender may, alternatively or in combination with the foregoing, purchase a number of points for a certain number of dollars such that the “currency” of the site experience is that products cost points and points are purchased with dollars when funding the account.

A second purchase and payment method includes creating an account and purchasing gift credits or points with a credit or debit card, then using those credits to purchase the gift. The sender's account is debited for the points used to purchase the gift. In this purchase method, rather than fund the account and then use those funds or points to make the gift purchase, the sender would enter their credit card and billing information into fields on the website and execute a credit card purchase via a standard online credit card processing vendor for the exact value of the desired gift then proceed to the next step of the gift giving process.

A third purchase and payment method includes entering credit or debit card information and purchasing just the single gift without creating an account. In this method, the sender does not even create an account, and the sender simply executes the individual process as in the second purchase and payment method described above.

A fourth purchase and payment method involves an alternative to payment, whereby the gift giver (sender) may so something to be eligible for a gift, i.e., complete a survey, sign up for a service, or some other program where the gift is the incentive. In this instance, the gift giver may also choose to be the gift recipient.

After the sender has selected the payment method and either funded his/her account or purchased the selected gift, the sender is presented with another graphic screen (such as may be displayed on a mobile telephone or computer) that allows the sender to enter into a series of fields or select from the graphic screen any one or a combination of the following: a personal message for the recipient, the sender's own name, and confirmation of the gift the sender has selected. After the sender confirms selection of the gift and clicks a “send gift” button on the graphic screen, the system constructs and sends communication (for example, via MMS, SMS, or other protocol) to the gift recipient by passing the message through to the cell phone carrier via a standard aggregator.

In some embodiments, to communicate with the system via shortcode rather than via the website, the gift sender sends specifically formatted messages to the system shortcode in order to select and send gifts. For example, the sender could send a text with a search keyword to the system shortcode along with a search string (SEARCH coffee to [shortcode]) and the system would reply with a multiple product ID's that match the search parameters. The sender could then send another text with a give keyword that would actually trigger the system to send a gift to the designated recipient (GIVE [productID] to [recipient cell #] to [shortcode]). When giving via text message, the sender would have an account in the system preloaded with funds sufficient to cover the gift being sent. It will be appreciated that search strings and message strings having syntax other than described above can be used with [productID], [recipient cell #], [shortcode] and/or other string parameters.

Upon receipt of the gift message, the recipient then takes a gift code (for example, code 44) in the message to a participating retailer associated with that product or to the online store (for example, retail website) where the code is entered at the point of sale and the recipient gets the gift. The gift codes delivered via mobile message can be of multiple types depending on each retailer's needs and existing POS system. The gift codes can be gift card numbers drawn from a pre-approved set of numbers and funded with the appropriate dollar amount sufficient to cover only the amount of the gift purchased by the sender for the recipient. The card is activated and funded only when the message is delivered to the recipient's mobile phone. At point of sale and after a single use, the card is zeroed out and deactivated by using the retailer's gift code and point of sale infrastructure. The gift codes can also be single-use coupon codes, distributed from a prearranged set of numbers, such that the recipient can purchase any item of a certain, pre-determined type, regardless of cost, and that coupon is valid only once and is cancelled using the retailer's existing coupon infrastructure.

At redemption, the recipient shows the gift code to the cashier or enters the code into a field online at checkout. The POS system recognizes the code as valid and active (since it was activated by the system at purchase by the sender) and the recipient is given the gift. If the gift code is a gift card number, the entire balance of the gift card is reduced from the purchase (zeroing the card) and the gift card number is deactivated. If the gift code is a coupon code, the cost of the gift item is reduced from the purchase price total and the coupon code is deactivated so that it cannot be used a second time. In either case, any remaining items purchased must be paid for by the recipient. When the gift code is a coupon code or a gift card number, the redemption process can be completely independent of the gifting system and relies on the retailer's existing infrastructure, thereby making it possible to integrate with any retailer that uses coupons or gift cards as part of the retailer's point of sale.

In some embodiments, the gift messaging system described above is a web-based system running a two-tiered web application with a PHP-based front-end that utilizes an open source LAMP stack (Linux-based web servers running Apache with MySQL and PHP for the database and front-end layers) coupled with Ajax interactivity in browser to speed up the user experience and a Java servlet running in Glassfish on the back-end for all of the messaging, financial transactions, and reporting functions.

The above described methods and computerized systems support the purchase of transaction IDs (for example, the code 44 above) that are delivered directly to a mobile device, and can be leveraged by the user (for example, the “recipient” above) of that mobile device to receive a specific item once that transaction ID is provided to and processed within a retail channel, the retail channel including without limitation a physical retail store that can be personally visited by the user and a retail website accessible through the Internet. The consumer (i.e., sender or person giving the gift) may purchase a transaction ID from any sales channel, the sales channel including without limitation a mobile application, a website, a social networking application, a call center and a physical retail location. The purchase of the transaction ID may be tendered using a credit card or debit card, a prepaid account ID, any web-enabled payment vehicle such as PayPal®, or cash. The transaction ID that is purchased could include but is not limited to a code that is dynamically generated by the central processing system 16 (FIGS. 2 and 3) or computerized system 4 (FIG. 1); a code that is retrieved from an inventory of codes (for example, the gift catalog 20) housed within a central processing system 16 or computerized system 4; a retailer-specific code that was provided in advance by a retailer or formatted as requested by the retailer; a third-party code generated by a third party that processes promotions for the retailer (such as those that are produced for existing couponing programs); or a payment-processor code that is generated by a payment processor that is partnered with a given retailer (such as those that are produced by a gift card processor, an acquiring bank, an issuing bank or a credit/debit network). Any of the foregoing codes can be uniquely associated with a specific gift at a specific retailer or with an individual gift transaction, which can be tied to the gift and retailer as well as to the sender, recipient, transaction time and other details of the individual gift transaction.

The mobile device that receives the purchased transaction ID (for example, device 5 in FIG. 1 and device 30 in FIGS. 2 and 3) may be a voice-only mobile phone, an Internet-enabled mobile phone (e.g., mobile phone configured with hardware and software for 2-way wireless communication through the Internet), an Internet connected mobile PC, a virtual point-of-sale terminal, or any other device that wirelessly connects to a wide or local area wireless network. The purchased transaction ID may be received by the mobile device in one of several ways that include but are not limited to (i) real-time delivery of the specific code via SMS, MMS, e-mail, application, website or other vehicle leveraged by the mobile device; (ii) delivery of the code via the same vehicles based on a scheduled event such as a specific date (e.g., a birthday) or time (e.g., 7:00 should the sender want the recipient to see an image of or information about the gift early in the morning); (iii) delivery of an alert or message which enables the recipient to retrieve the code when desired, such as simple instructions to click on a link to retrieve the code when at the retail location or website; and (iv) any combination thereof. Non-limiting examples of a specific item that is received by the consumer via the transaction ID include (i) a specific product, such as any given stock keeping unit (SKU) sold by a retailer; (ii) a service sold by a retailer that may not have a standard SKU value, such as a spa treatment, legal services or other service of value; and (iii) a discreet promotion offered by that retailer or a partner of that retailer, such as a percent off a given item, a secondary item when a primary is purchased, or the accrual of credit or value that can be collected to receive future benefit.

Processing of the transaction ID involves the transmission of the transaction ID from the mobile device to the retailer's point of sale (POS) system (for example, POS system 70), which may include any one or a combination of: reading of a human-readable number; machine scanning of a graphic rendered on the mobile device such as a bar code; wireless transmission from the mobile device to the POS system; back-end delivery of the transaction ID from a central processing system to the POS system. Furthermore, the processing of the transaction ID is supported by subsequent interaction between the retailer's POS system and the central processing system(s) of one or more entities that support the processing of the transaction IDs specific to that retailer. Subsequently, a retail channel through which a gift item or service is received can be, without limitation, any one or a combination of: a physical POS location (for example, a store at a shopping mall), a retailer website, a mobile phone application that is unique to a retailer and that is accessed via the mobile device, a call center operated by a retailer, and any other channel through which a retailer enables the purchase of items as defined above. The purchase may also create a graphic version of the gift as well and gift messaging which is published through a social network (for example, Facebook®), mobile platform, or online platform. The purchase may also result in a “thank you” message by the gift recipient via mobile, e-mail or social network.

Embodiments of the present invention include features for gift card number security and fraud protection. A custom algorithm is implemented for the calculation of multiple check digits for a gift card number such that the number can be split into two sections and combined during the transmission for authorization. The first section will be embedded within the payment processing system, and the second section is exposed to the customer and store personnel. Redemption can only happen when both numbers are combined. In some embodiments, the code 44 (FIGS. 2 and 3) comprises a first code portion and a second code portion, the first code portion and second code portion are located separately from each other on a gift card. The first code portion is embedded within a payment processing system of the gift card. The second code portion is visible on the gift card.

In some embodiments, the first code portion is associated with a specific gift or service, is sent to the recipient's communications device, then provided by the recipient or the recipient's communication device to a retail point-of-sale system (such as POS system 70). The second code portion is uniquely associated with the recipient. The second code portion can be a mobile telephone number. The second code portion can be provided verbally by the recipient to retailer and input into the retail point-of-sale system. The combination of the two code portions represent a single unique code that fully identifies the gift transaction, such that all elements of the transaction may be tracked including the specific gift or service that was selected by the sender, the specific retailer of the selected gift, the recipient of the gift, the sender, and other relevant details. The first and second code portions must be received by the retail point-of sale-system and validated by either the retail point-of-sale system or a computer system (such as system 4, system 16, or other system) to allow the recipient to receive the selected gift. The first and second code portions can be combined by the computer system such that the resulting combined code may be communicated back to the retailer point-of-sale system at one time after having received the second code portion from the retailer point-of-sale system.

Embodiments of the present invention include features for mobile gift delivery. Mobile gift delivery includes: purchasing real gifts via any one or a combination of a web interface, mobile application, social network platform (for example, Facebook®), and SMS shortcode message; and delivering product redemption codes via text messages that can be redeemed in retail locations or online for real products. The gift codes delivered via mobile message can be of multiple types depending on each specific retailer's needs and existing POS systems.

Embodiments of the present invention include redeeming mobile gifts via mobile payment type. The system (for example, system 4 in FIG. 1 and system 16 in FIGS. 2 and 3) is integrated directly to the POS system of the retailer. Rather than distributing gift cards or coupon codes via text messages, the system is integrated directly to the POS system of the retailer and distributes gift codes that are correlating with a specific-user account and a specific gift transaction. The recipient receives the gift code, which is later entered by the retailer's cashier or into a field in an online system at redemption. The gift code is unique to the particular gift transaction initiated by the sender, is associated with the sender's account, and can only be redeemed once. When the recipient presents or enters code at the point of sale, the retailer's POS system or website then contacts the gift system (for example, system 4 and system 16) through the Internet via a live API and requests approval of the code much the same way a VISA (R) credit card transaction is approved in real-time via a credit card terminal or a gift card transaction is approved by a processor such as First Data®. The gift system responds through a network via an API, and either accepts or declines the gift code depending on whether the gift had been previously redeemed or not. In this way, the gift system can approve or reject (in the case of duplicate usage) redemptions in real-time based on whether or not the gift code is valid and unused.

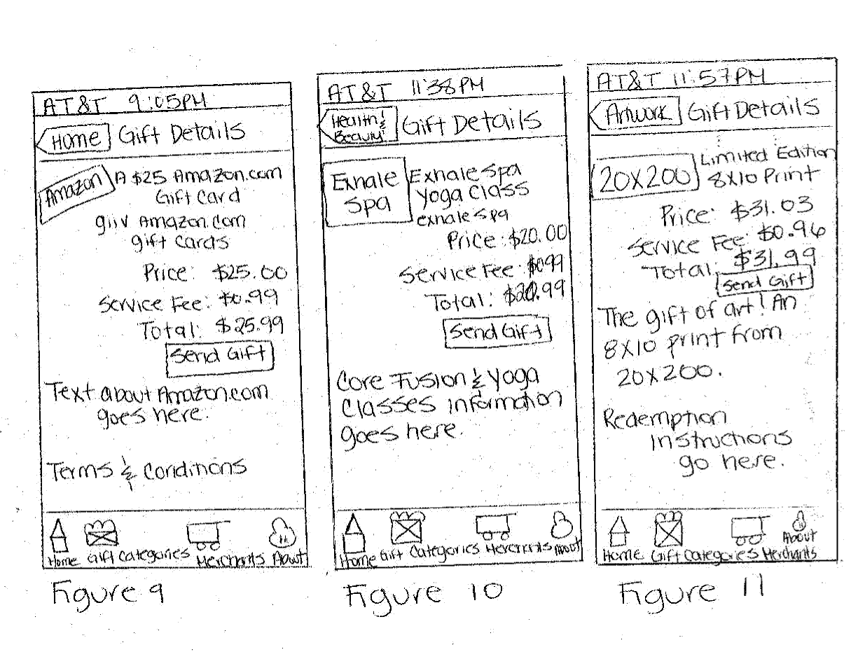

FIGS. 7-23 show a method of giving a gift that involves use of a software application running and stored on processors and memory devices of a communications device (for example, devices 3, 5 in FIG. 1 and devices 12, 30 in FIGS. 2 and 3). The software application can be configured to operate on an iPhone (R) from Apple Inc., Cupertino, Calif. The software application (hereinafter “application”) enables people to browse featured gifts, select categories, or merchants.

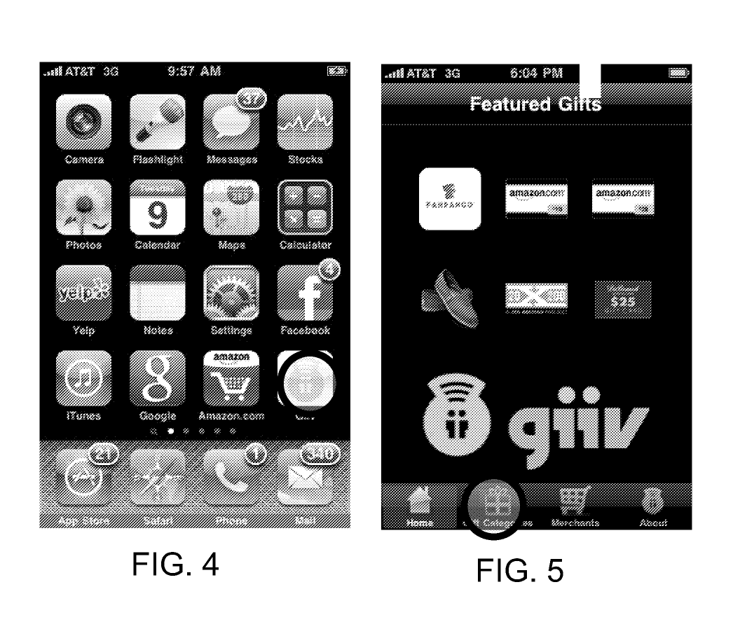

FIG. 4 shows a display screen on the communications device of a sender of a gift (for example, sender 2 in FIG. 1 and sender 32 in FIG. 2). The display screens shows icons for a plurality of applications, one of which (indicated by a circle) is the icon for the software application for giving a gift (hereafter “Giiv application”). The Giiv application is stored in and runs on the sender's communication device (for example device 3 and device 12) and interacts with software modules stored in and running on a central system (for example, system 4 and system 16).

FIG. 5 shows the display screen on the sender's communications device after the icon for the Giiv application has been selected in FIG. 4. The display screen shows icons for featured gifts that are available for selection. A navigation bar at the bottom of the screen shows icons for browsing gifts by category and merchant. The display screen can be touch sensitive, which allows the sender to make selections and enter text by touching the displaying screen.

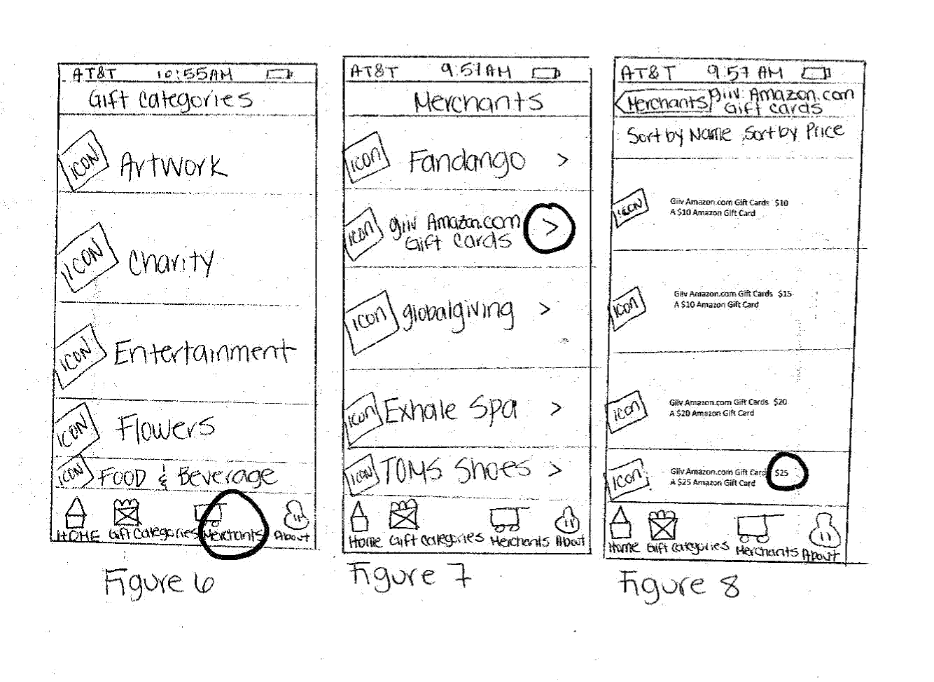

FIG. 6 shows the display screen on the sender's communications device after the icon for “Gift Categories” (indicated by a circle) has been selected in FIG. 5. The display screen shows a listing of different gift categories into which available gifts have been categorized.

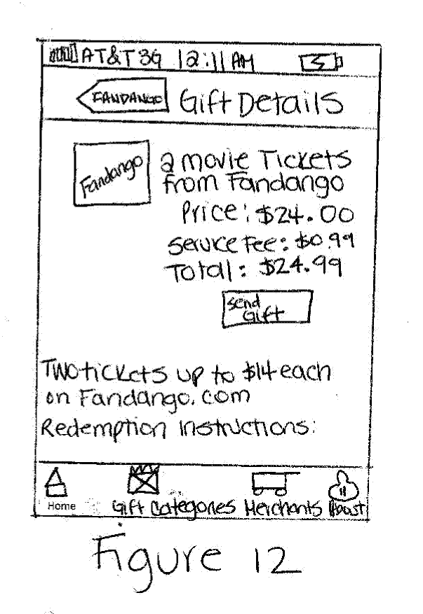

FIG. 7 shows the display screen on the sender's communications device after the icon for “Merchants” (indicated by a circle) has been selected in FIG. 6. The display screen shows a listing of different retailers and associated icons. After the sender clicks on a particular retailer icon (for example, the icon for “Amazon.com Gift Cards” as indicated by a circle), the display screen is updated as shown in FIG. 8. FIG. 8 shows a listing of various denominations of gift cards. After the sender clicks on a particular gift icon (for example “$25 Amazon.com Gift Card” as indicated by a circle), the display screen is updated as shown in FIG. 9. FIG. 9 shows a detailed description of the particular gift and any terms and conditions that apply to the particular gift. FIGS. 10-12 show alternative screen shots for other types of particular gifts, such as a Spa Yoga Class (FIG. 10), limited edition 8×10 print (FIG. 11), and two movie tickets (FIG. 12).

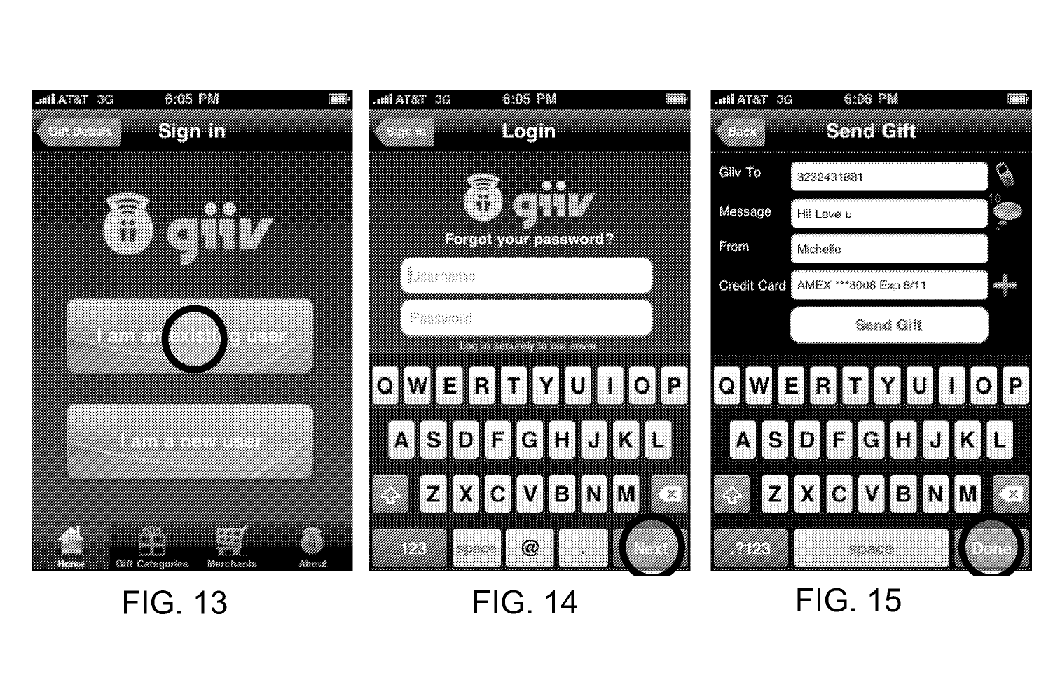

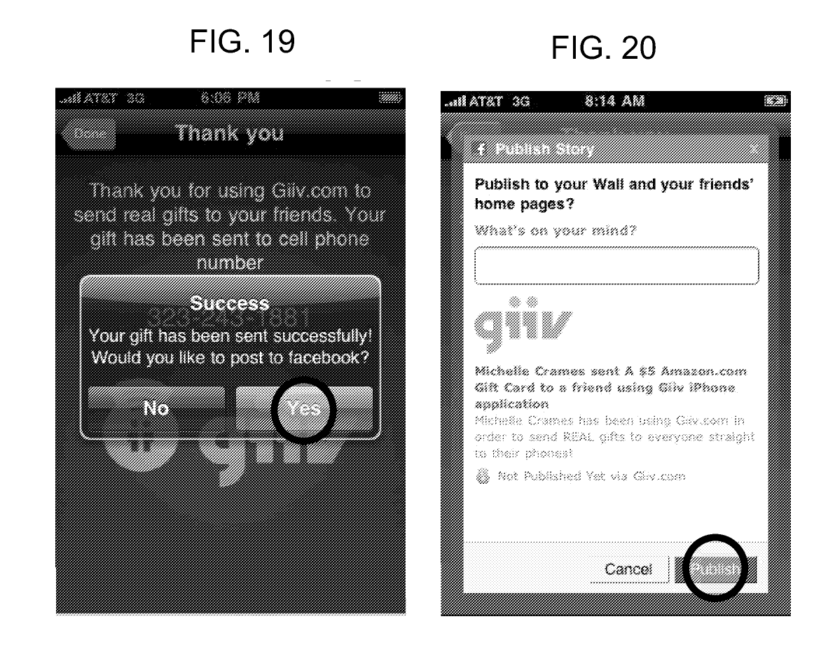

Screens having detailed descriptions of particular gifts (FIGS. 9-12) also have a “Send Gift” button, which when selected or “clicked” causes the display screen on the sender's communications device to be updated as shown in FIG. 13. The updated screen in FIG. 13 prompts the sender to indicate whether he or she is a new or existing user of the Giiv application. If an existing user, the sender is prompted to login into a pre-existing account owned by the sender on the computerized gift giving system (for example, system 4 and system 16), as shown in FIG. 14. After a “Next” button is selected (as indicated by a circle in FIG. 14, the sender is prompted to provide information that specifies the recipient of the gift by telephone number, a personal message to be delivered to the recipient, the name of the sender, and method of payment, such as shown in FIG. 15. A touch screen keyboard at the bottom of the display screen can be used by the sender to manually enter the information to the communications device for transmittal to the computerized gift giving system. After a “Done” button is selected (as indicated by a circle in FIG. 15), the sender is prompted to decide whether to post or publish a message to the recipient's social networking account and/or the sender's social networking account, as shown in FIG. 19. The social networking account can be hosted, for example, by Facebook®.

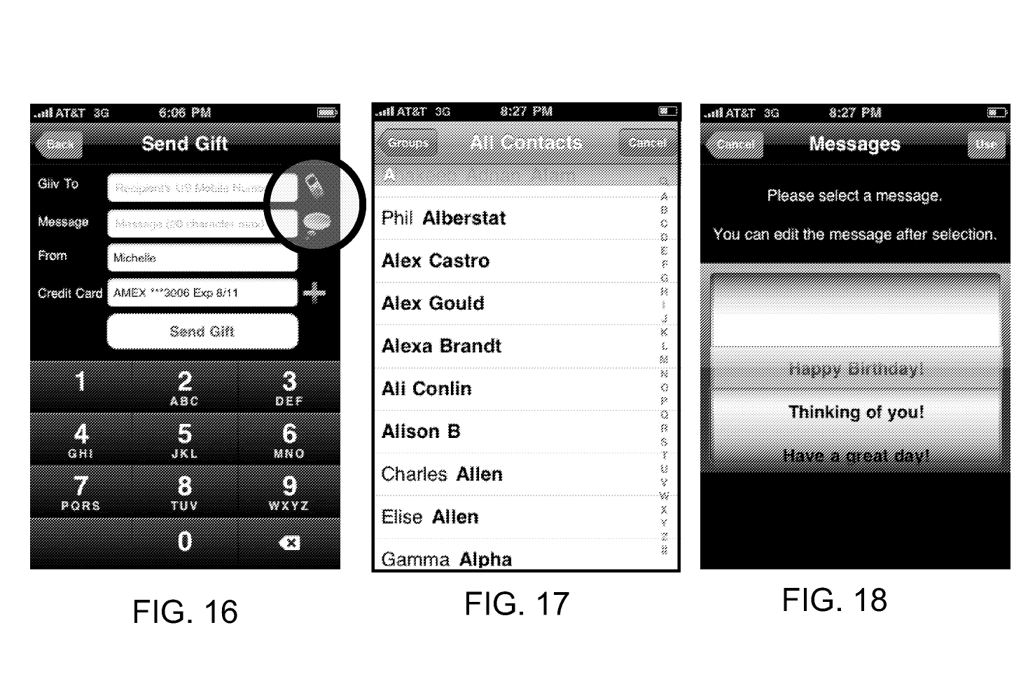

Referring again to FIG. 15, instead of manually entering the recipient's telephone number, the recipient's telephone number may be imported from a preexisting contacts list stored in a memory device of the communications device. After clicking on an icon adjacent the empty recipient field, as indicated by a circle in FIG. 16, the display screen is updated with the contacts list from which the sender selects the intended recipient, as shown in FIG. 17. Also, instead of manually entering a personal message, a personal message may be imported from a preexisting list of pre-populated messages. After clicking on an icon adjacent the empty message field, as indicated by a circle in FIG. 16, the display screen is updated with a message list from which the sender selects a pre-populated message, as shown in FIG. 18.

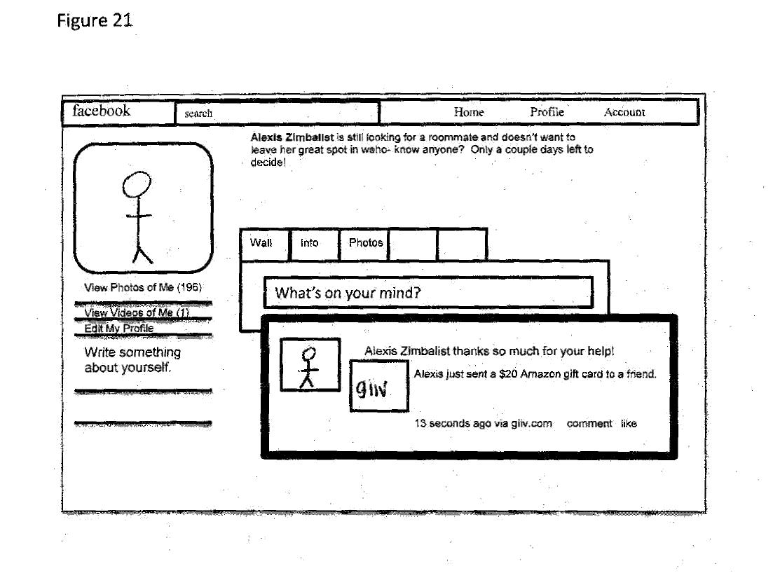

Referring again to FIG. 19, after the sender chooses to publish a message on Facebook® by selecting the “Yes” button (as indicated by a circle in FIG. 19), the display screen is updated to prompt the sender to enter a message. After clicking on the “Publish” button (as indicated by a circle in FIG. 20), the gift giving system pushes or transmits the message to the appropriate social networking account, causing the message to appear, as shown in FIG. 21, with a hyperlink to a website for the gift giving system and an opportunity to add an additional personal message, which can include a graphic logo or image of the gift item and/or the retailer, if desired. FIG. 21 shows a screen shot of the recipient's communications device.

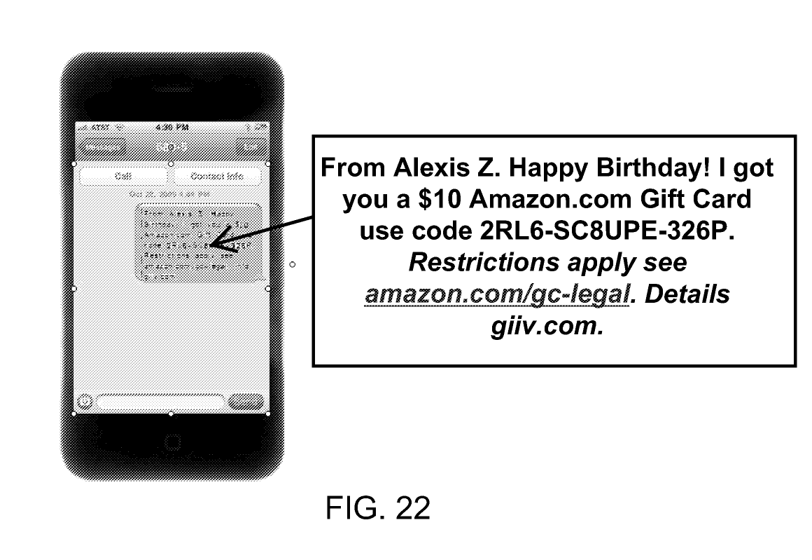

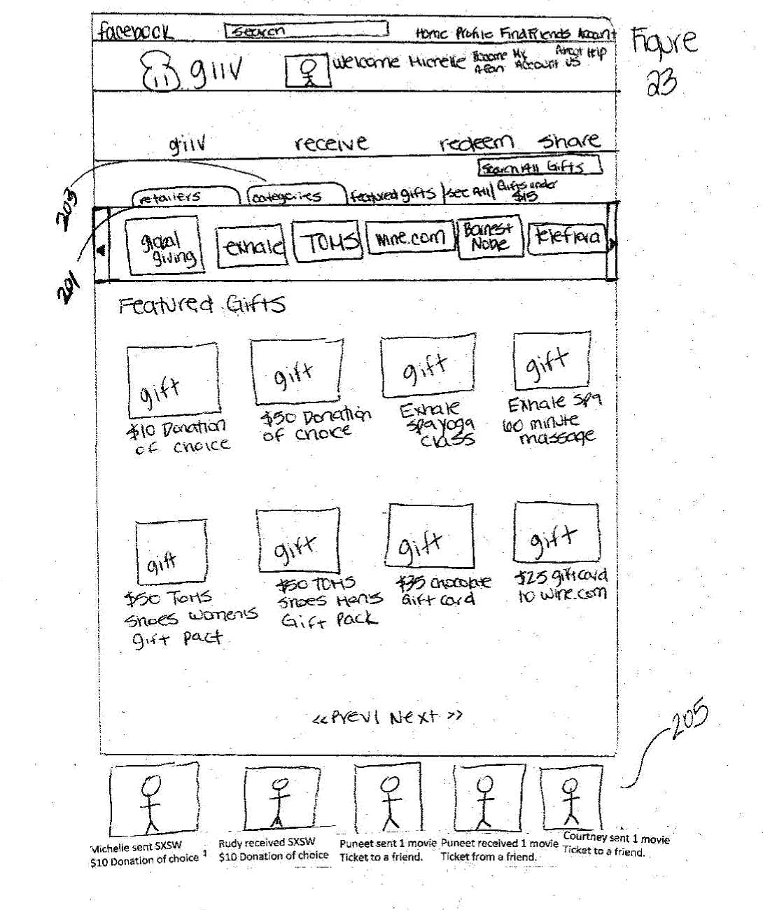

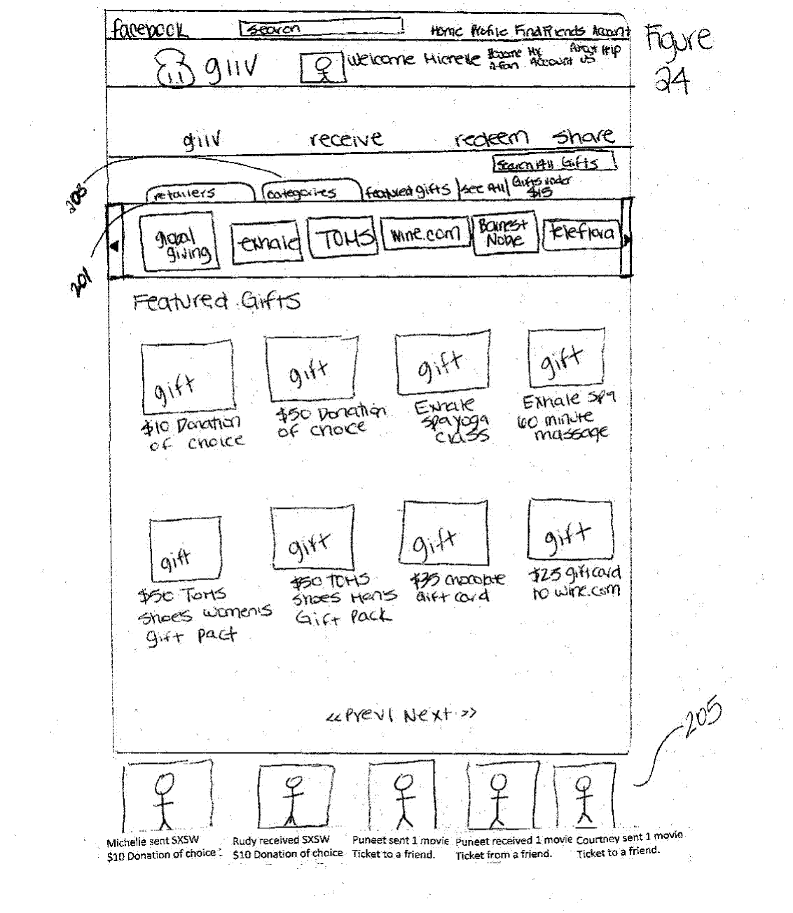

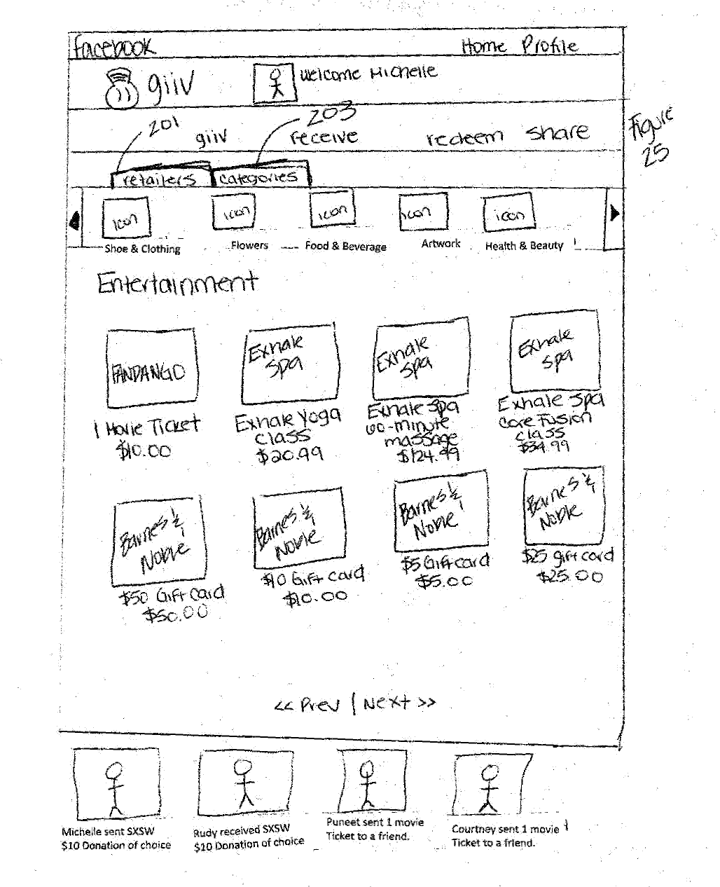

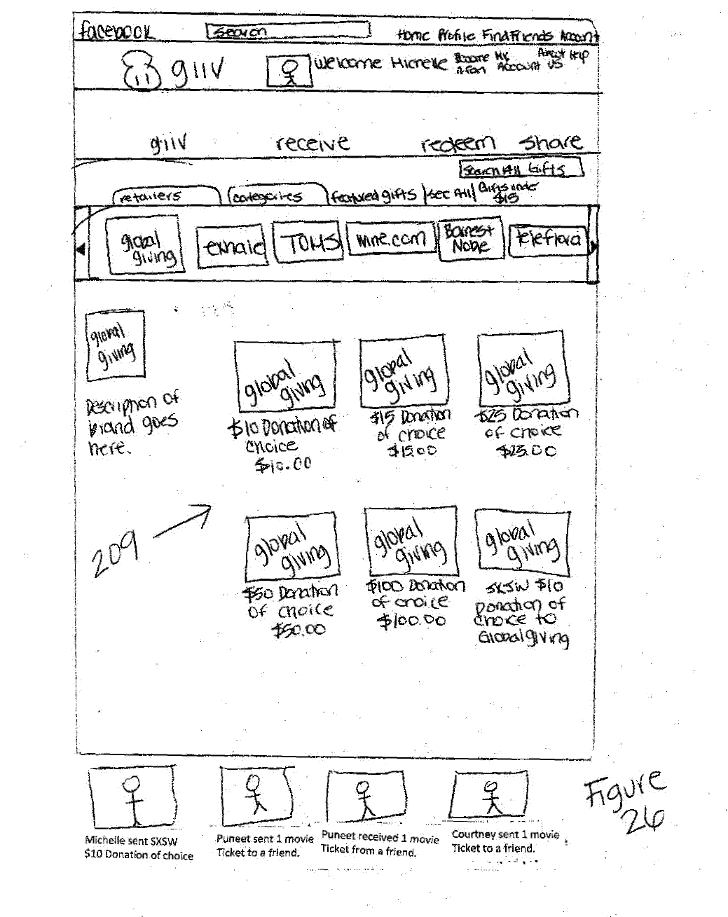

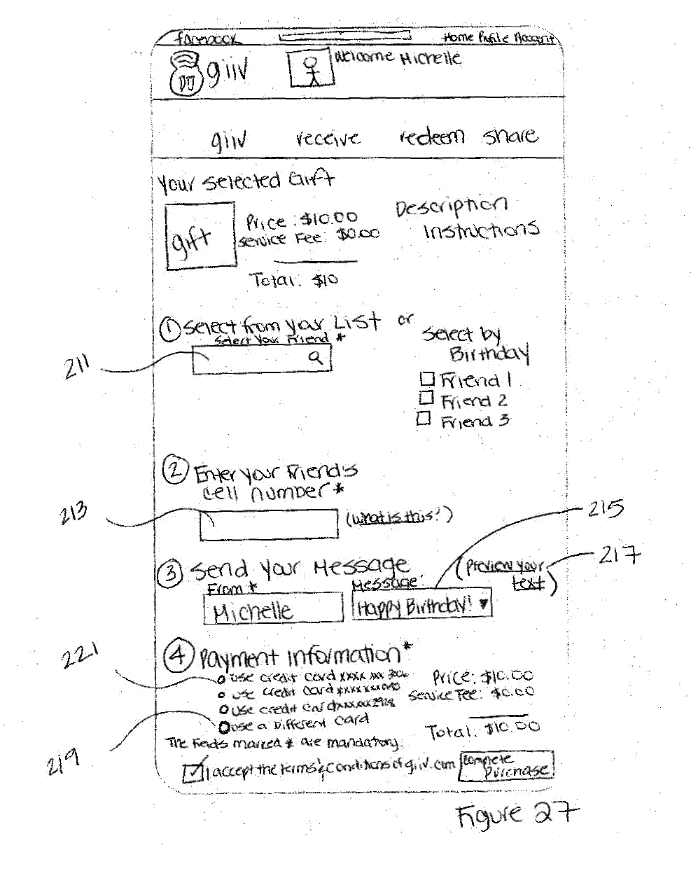

As shown in FIG. 22, the recipient will also receive the message on his or her communications device, including additional information about the gift and specific retailer and any legal text, thereby informing the recipient where to obtain the gift.

The sender will also receive a conformation message regarding the gift transaction. The confirmation message can be sent by the gift giving system to the e-mail address of the sender, the e-mail address information having been previously stored in the gift giving system (for example, the user management system 18 in FIG. 3).

In some embodiments, the sender is not an individual person, but is some other sending party or entity, such as a corporate entity. The entity can be sending the recipient a gift as a result as a result of a specific activity or classification of the recipient. For example, a corporate entity may give a gift to the recipient in accordance to the methods and systems previous described as part of a consumer reward or incentive program. A non-limiting example of a reward or incentive program is that a corporate entity, such an automobile manufacturer, gives a gift to the recipient because the recipient is a Facebook® fan of the corporate entity.

Embodiments of the present invention include coordinated virtual and physical gift delivery. The web system that drives the mobile gifting utilizes Facebook Connect and similar application programming interfaces (“API's”) to deliver a virtual version of the same gift (e.g., an image of the gift) at the same time the real gift code is delivered to the recipient. For example, after the sender 10 selects the gift and recipient of the gift, and after the selection is communicated to the central processing system 16, the central processing system automatically sends to an account on a social networking website (for example, Facebook®) a communication about the gift. The account on the social networking website is owned by the recipient. The central processing system 16 uses an API customized for the social networking website.

### Giiv Facebook® Application and Giiv Website

By way of background, Facebook, Inc. of Palo Alto, Calif. allows people and corporate entities to create their own individual Facebook® account or profile corresponding to a user customized webpage (hereafter “profile”) that exists within or is accessed through a website of Facebook, Inc. Each profile can be selectively linked to other profiles of personal friends and other entities, thereby forming a social network. Each profile includes what is referred to as a “wall,” which is a webpage with a “publisher” utility into which the profile owner may enter comments or what ever is on his or her mind. Comments, notifications, status updates, and other information pertaining to an individual profile can appear or be automatically transmitted to the “wall” of other profiles on the social network. Other utilities and functionalities can be added to or made accessible on an individual profile by a process in which the profile owner adds a “tab” to the profile webpage. Thereafter, the profile owner can access the utility or functionality by selecting the corresponding tab on the profile webpage.

Embodiments of the present invention include a Facebook® software application (referred to as the “Giiv Facebook® application”) that offers a catalog of items and retailers on the Giiv Tab, which is a tab within the Facebook® application that takes the user to specific content provided and enabled by a Giiv computer system (such as system 3 and system 16, or other system). By selecting the Giiv Tab, a profile owner or user (such as sender 10 in FIGS. 2 and 3 or other sender) can go to a website (referred to as the “Giiv website”), log into his or her account (if applicable), and select a gift, or browse by retailer, or gift category.

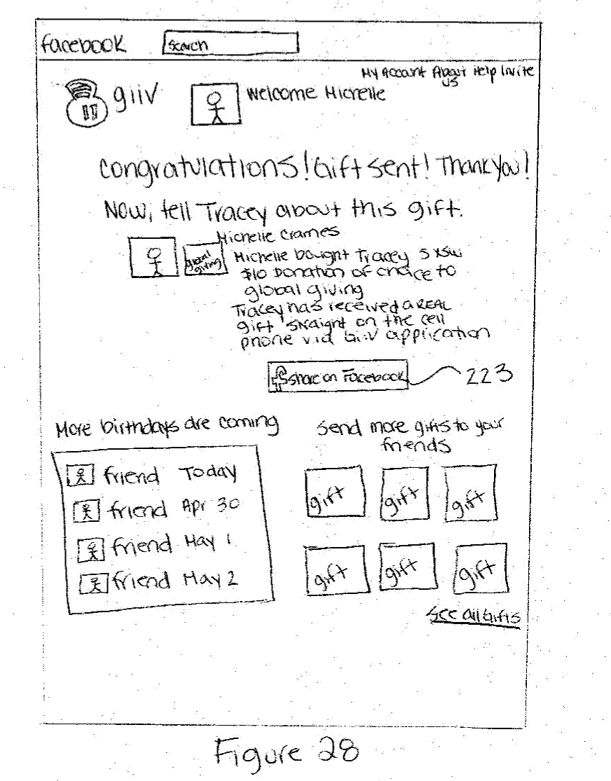

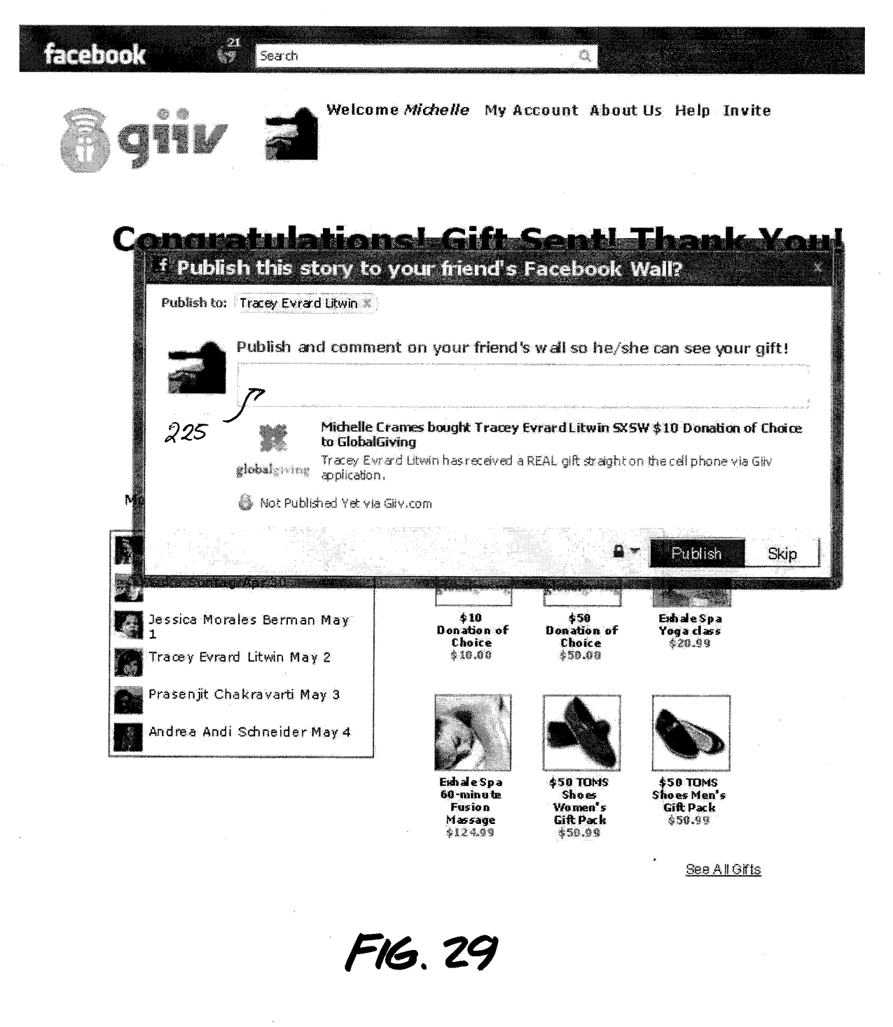

FIG. 23 shows a page on the Giiv website. The user can click on the “retailer” tab 201 to see logos and names of available retailers on a retailer page. FIG. 24 shows a detail view of the retailer page. The user can click on the “categories” tab 203 to see available gift categories on a categories page. FIG. 25 shows a detail view of the categories page. Users can also see all gifts, search for products, or see gifts in particular price categories. Users see recent gifts (from friends or others) on the bottom 205 of the application page.

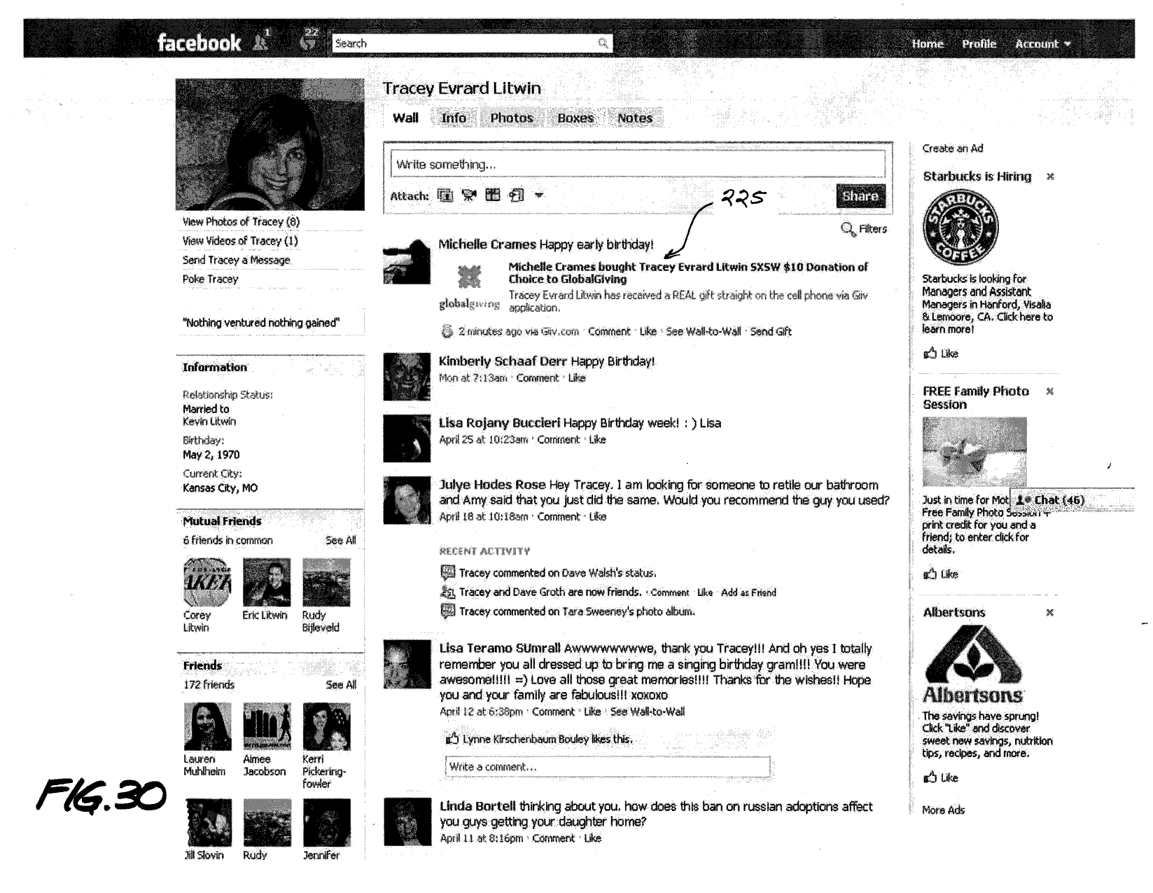

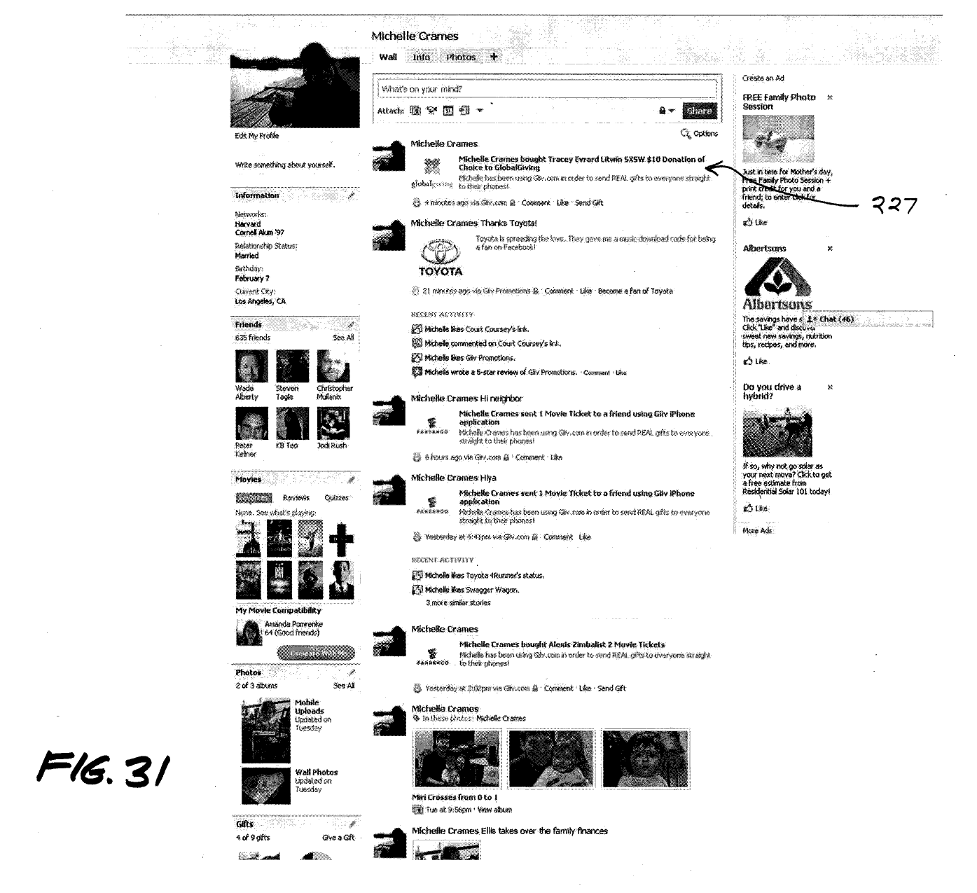

In operation, the user clicks through to a product (intended gift), as shown in the listing 209 of products in FIG. 26 for one particular retailer. Thereafter, as shown in FIG. 27, the user selects his or her friend 211 (intended gift recipient), enters a phone number 213, enters a message 215, and previews the message look and feel by clicking a hyperlink 217. The message 215 will be sent to and received by the recipient's phone. Next, the user enters his or her credit card number 219 or uses a credit card number stored 221 in the user's account, completes the purchase.

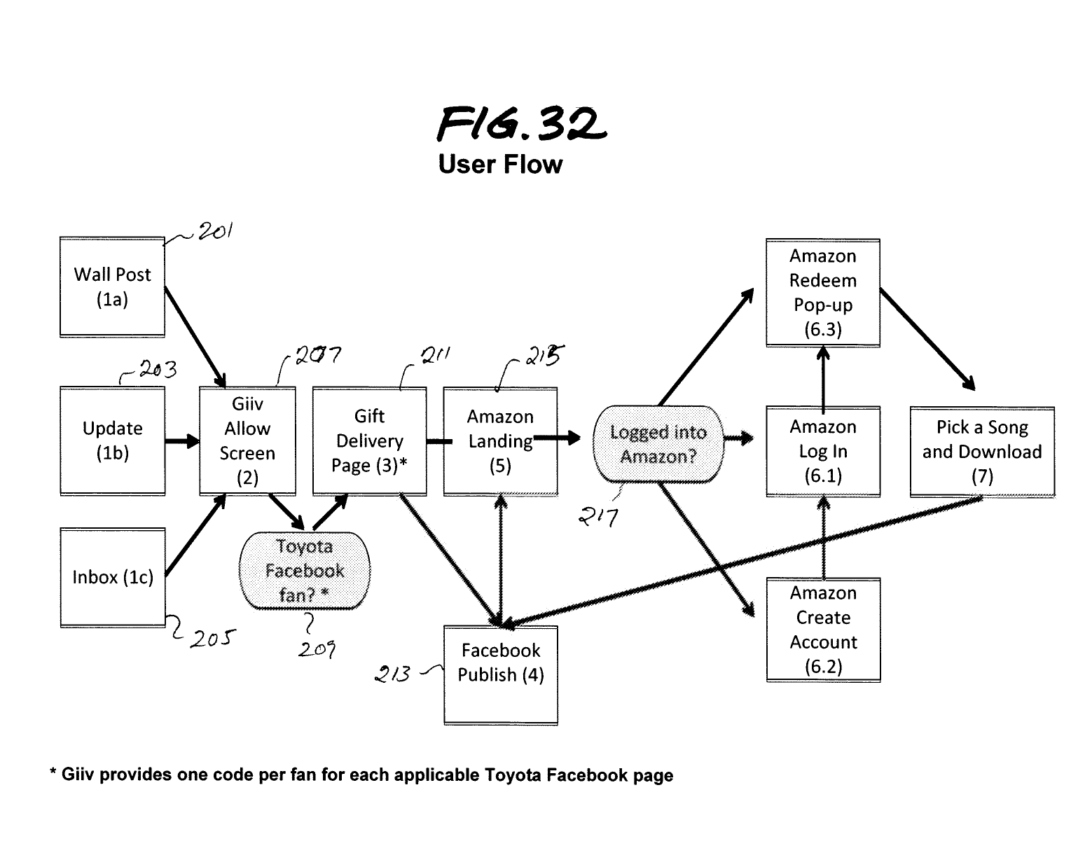

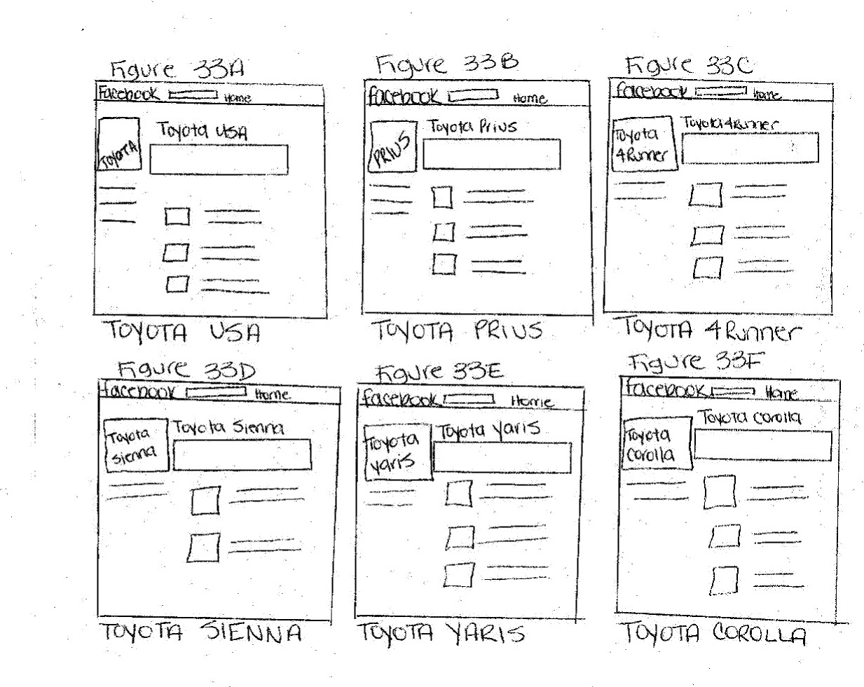

After gift is stent, the sender gets a Gift confirmation page, as shown in FIG. 28, and has the option to publish 223 the gift into the gift recipient's Facebook® wall to allow friends of the recipient to know about the gift. When choosing the publish into the recipient's Facebook® wall, the user gets a pop-up window, as shown in FIG. 29, in which the user can manually enter a comment 225 for publishing into the recipient's Facebook® wall. Publication of the comment 225 into the recipient's Facebook® wall is shown, for example, in FIG. 30. Information 227 about the gift appears on the sender's Facebook® wall, as shown in FIG. 31.

### Profile-Specific Facebook® Tab

The Giiv Facebook® application feeds retail specific content to retail partners, including mapping to individual physical store or web pages within the retail online domain in order to track referrals, sales, affiliate programs, etc. This is described below.

In addition to gifts on the Giiv Facebook® application, Giiv also provides a tab on individual profiles of Facebook® users. Each Facebook® user profile has a unique ID number. The Giiv Facebook® application uses that ID number to track specific information related to a consumer's profile for retail partners and affiliates when the consumer adds the Giiv tab. Different profiles show different information in the following way: the Giiv Facebook® application tracks the products featured on the individual Facebook® tab within a consumer's profile such that for example if the user only wants a specific retailer, only the specific retailer's items are visible to the user, and other retailer logos and items are not visible. For example, for Teleflora®, only Teleflora® items show up on the Teleflora® tab on their Facebook® profile. Similarly for GlobalGiving (R), only GlobalGiving® items show up on the GlobalGiving® tab. The same may also apply for a particular category of products, or particular selection of products, in essence a storefront. These items automatically populate on the tab of the Facebook® profile when the consumer adds the Giiv tab (it is dynamically generated at a retail level to show only those retailer products based on the Facebook® profile id). When a gift giver clicks on an item to buy, they go into the Giiv app at the Product detail page (see above process), and do not see other retailer logos or items. A Giiv computer system (such as system 3 and system 16, or other system) tracks the source of the transaction, such that the origin can be traced back to the Facebook® profile and sales can be attributed to that profile. This serves as a tracking tool for affiliate programs and/or contests where a revenue share and/or prizes are given for referring sales to Giiv. This is useful as Giiv can track the source of transactions at the Facebook® profile level, and therefore incent and reward promotion of Giiv on a retailer-specific basis.

### Facebook® Fan Rewards Program

Although the description below make reference to a corporate entity, it will be appreciated that the description can apply to other types of organizations, for example and not limitation, governmental entities, educational entities, charitable entities, and non-profit entities.

A software application (referred to as “Giiv application”) is accessible through Facebook® profiles that can provide gifts (also referred to as “gifting”) to a particular group of eligible people through a social network and/or other electronic mechanism (including instant messaging, games, and email) and or distributed network (people who have used Facebook Connect on other sites, or a universal like on Facebook on other sites). In some embodiments, the software application operates within the system 4 or system 16.

A corporate entity or other owner of a particular profile webpage on Facebook® (referred to as “profile” or “profile webpage”) notifies persons who potentially meet certain criteria or who may have performed a particular action to be eligible (for example, fans, people who like a particular profile, people with a certain IP address or other criteria, people who have “liked” on facebook or other web sites connected to Facebook) by publishing a messages (referred to as “wall posts”) on their profile webpages. The wall posts provide notification of potential eligibility for a gift from the corporate entity. The wall posts include a hyperlink. The notified people (potential recipients of the gift) click on the hyperlink, which initiates a process by which they are confirmed of validated as having met predetermined eligibility criteria. For each notified person that clicks on the hyperlink, the Giiv application based on certain rules or criteria determines whether the person meets the criteria (for example, particular affiliation, geographic location, and others) and, if criteria are met, the Giiv application delivers a unique gift code to that person's profile webpage. If potential recipient is determined to have not meet the criteria, he or she has the option of performing a qualifying task that meets the criteria. In a non-limiting example, the criteria can be that a person is a “fan” of the corporate entities profile, and the qualifying task includes the person indicating, through his or her profile, that he or she likes the corporate entity's the profile. Such an indication can be forwarded by Facebook® to others in that person's social network. Upon receiving the gift code, recipients (owners of Facebook® profiles) can redeem the gift code immediately or at their convenience via the gift redemption methods described above. In some embodiments, redemption is performed through Facebook® and the gift code is uniquely associated with one profile owner to prevent use by another profile owner. It will be appreciated that recipients can access the gift code posted on their profiles by any number of communications devices, including without limitation mobile telephones and personal computers.

A recipient of the gift code (owners of Facebook® profiles) can then tell one or more of their friends about the gift, so they too can perform the necessary action to receive a gift from the same corporate entity. Then, they too can also publish to their wall that they received a gift.

In some embodiments, the Giiv application can give different gift codes in a random manner to various Facebook® fans of the corporate entity. For example, one of the gift codes can correspond to a grand prize of a sweepstakes, thereby providing further encouragement for profile owners to become a fan.

### Fan Appreciation Program Example

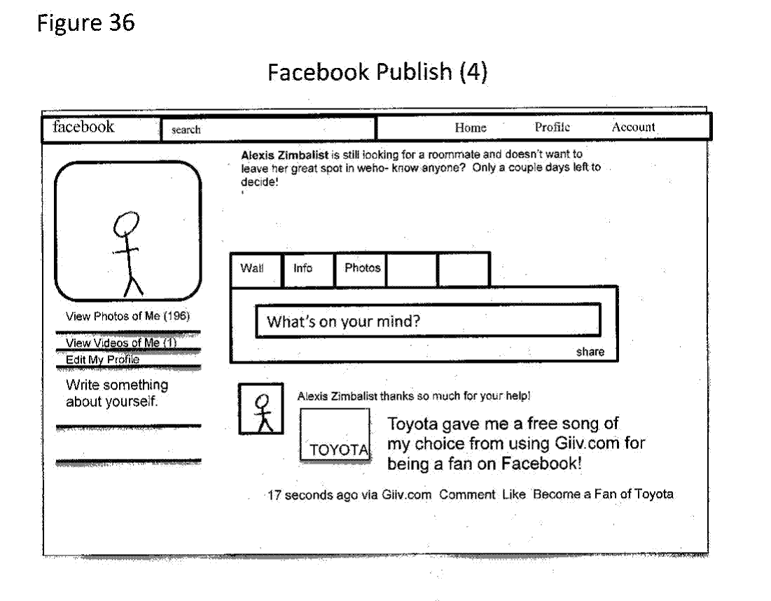

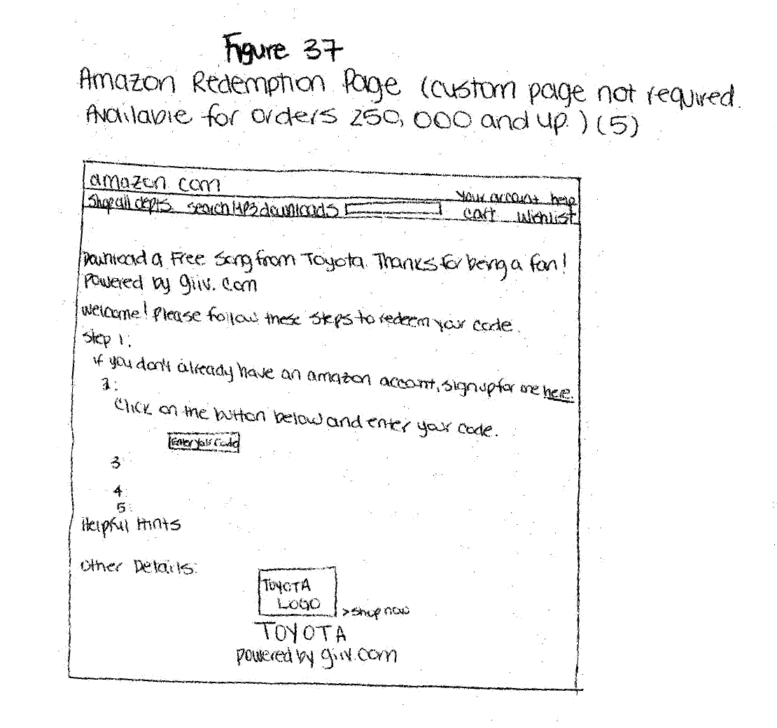

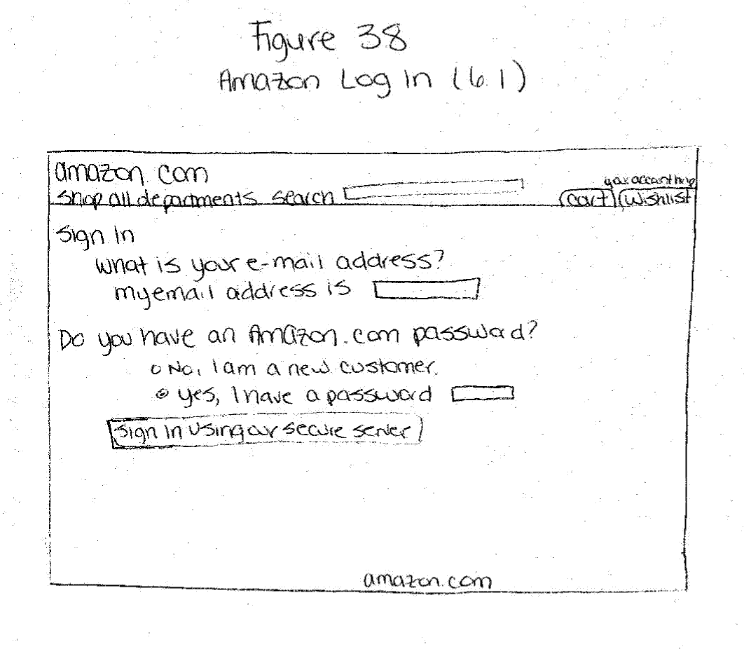

FIG. 32 is a flow diagram of a corporate rewards program. FIGS. 33-41 are screen shots of images displayed on communications devices at various steps in a method of giving a gift according to FIG. 32. Although the description below makes reference to an automobile manufacturer or one type of corporate entity, it will be appreciated that the description can apply to other types of corporate entities, to governmental entities, charitable entities, and other organizations.

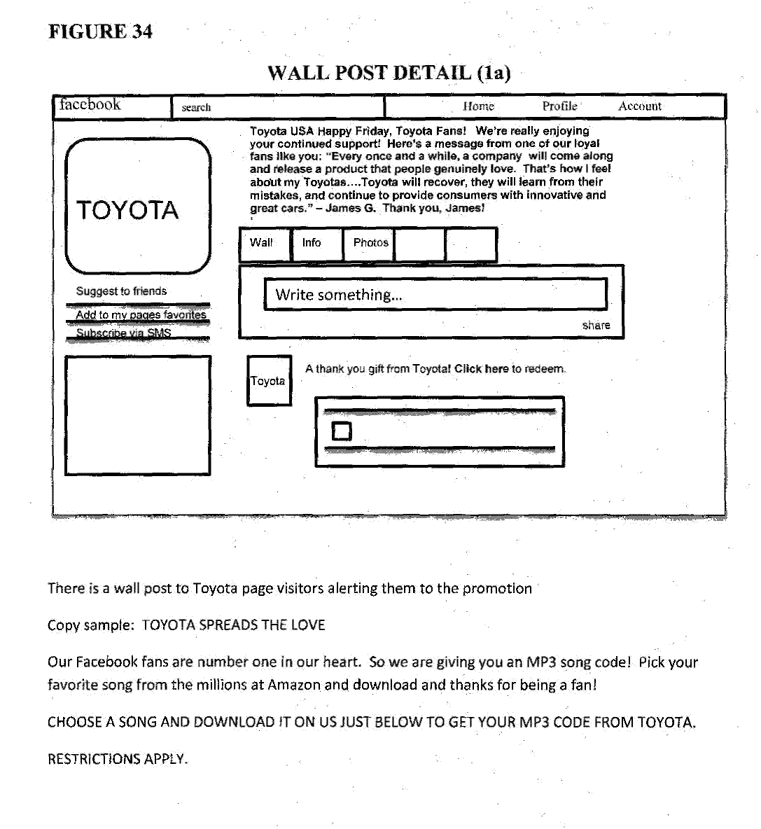

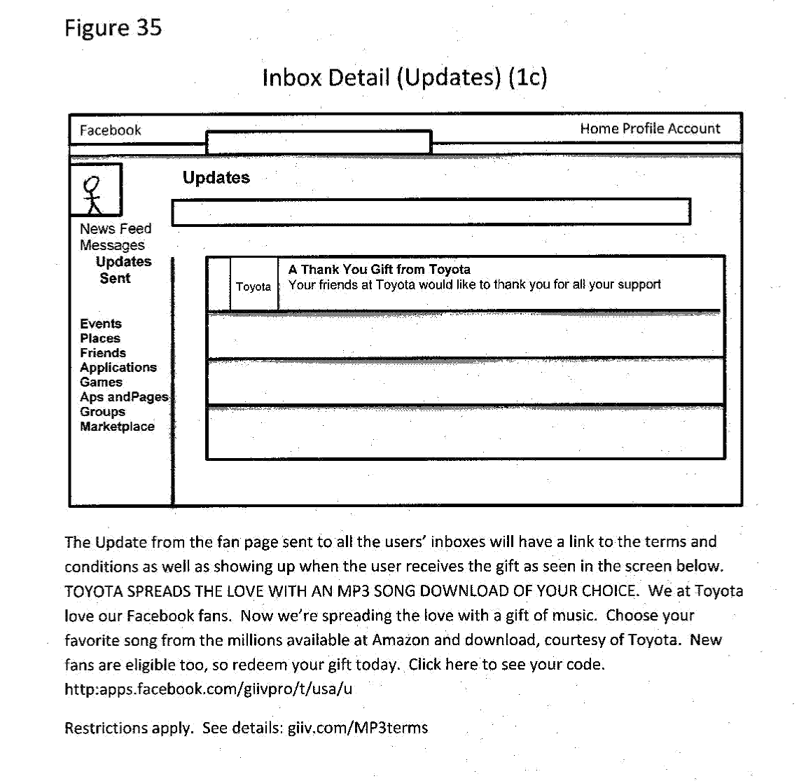

An automobile manufacturer may have one or more profile webpages on Facebook (R) (referred to as a “Fan page”). For example, the manufacturer may have profiles for various automobile models, as shown for example in FIGS. 33A-33F. Referring to FIG. 32, administrators of those profiles notify existing fans (Facebook® profile owners), through wall posts 201, updates 203, or messages to inboxes 205, about the manufacturer's gift of one free song redeemable from an online retailer channel, such as AmazonMP3. FIG. 34 shows an example of a wall post 201. FIG. 35 shows an example of an inbox message 205. The profile owners are instructed to click on a hyperlink in the received notification in order to claim or receive the gift. Each hyperlink is unique to a particular Fan page. Each link is identified as or includes an indication as to whether an incoming user (a Facebook® profile owner) clicked in from a wall post, an update of the Fan page, or an inbox message. By clicking the hyperlink, the user accesses a Giiv allow screen 207, which can be controlled by a Giiv application (for example, system 4 or system 16)

The Giiv allow screen 207 verifies 209 whether the user is actually a fan of one or more eligible pages and meets other criteria including having an IP address within the U.S. The application can offer one gift per user, or one gift per each Fan page the user is a fan of and/or that the users has indicated he or she “likes” within the Facebook® application. If a positive determination is made, users are shown a Giiv Gift delivery page 211 which presents the user with a gift code, a message customized for the corresponding Fan page, instructions on how to redeem or obtain the gift, and a “publish” button or other utility 213 that allows the user to inform or otherwise send a publicity notification to their social network that they received a gift. They receive a unique one-time use code that only that fan can see associated with that page that they indicated they “liked” within the Facebook® application. In the instance where they are eligible to receive multiple gifts for “liking” or being a fan of multiple pages, they would receive multiple unique codes, one for each eligible action. Users may receive a screen that the quantities are limited. In this instance, when the gifts given reach the total number allocated, new users who meet the eligibility criteria may receive a screen and message that they can no longer receive gifts due to limited quantities. However, those users who have received a code can go back at any time and see the same code again.

Some members of the social network may not be a fan of the corresponding Fan page, and the publicity notification that they receive may include instructions on how to become a fan. Some members of the social network may already be a fan of the corresponding Fan page, but may not be from an eligible geographic location (such as an eligible country) as determined by an IP check, so the publicity notification may include a message explaining the reason for ineligibility.

From the gift delivery page 211, users can elect to click on a “redeem now” button, which causes a gift code redemption webpage 215 of the retailer (for example, amazonMP3®) of the gift to appear on the communications device screen, wherein the user can enter the gift code. Where the gift code is for one free song, the user can then opt to select a particular song title or to return later to their account 217 on Amazon or a third party with whom the gift is being redeemed to choose a particular song title.

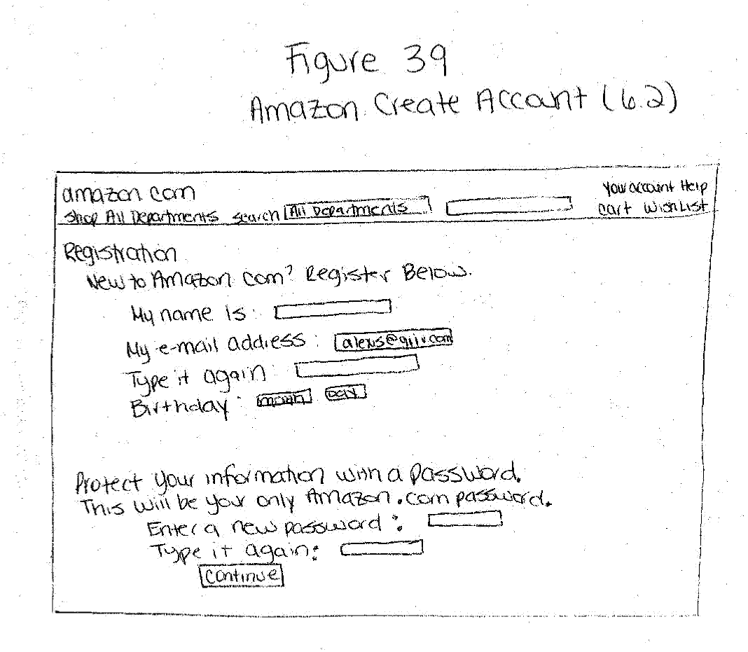

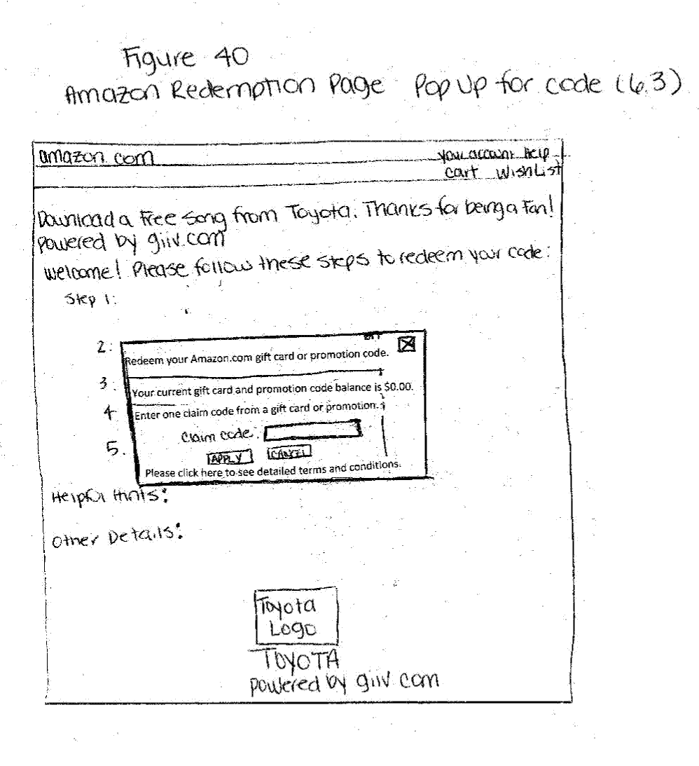

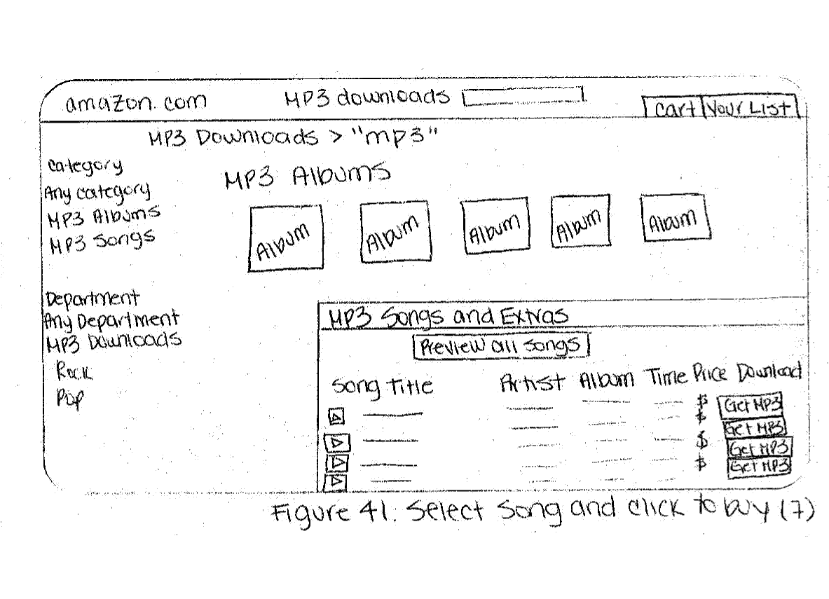

FIGS. 37-41 detail a process for gift redemption based on the Amazon example below. As depicted in the figures, the user accesses their gift, which in this example is an Amazon® MP3 file, by first logging into Amazon.com (R). They access the login point for Amazon® directly from the Facebook® application, as indicated in FIG. 38. If required, the user then creates an account, as depicted in FIG. 39, then enters the specific redemption code to access the selection of MP3s and choose the desired song title, as depicted in FIGS. 40 and 41.

While several particular forms of the invention have been illustrated and described, it will also be apparent that various modifications can be made without departing from the scope of the invention. It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

What is claimed is:

1. A method of giving a gift of a specific product or service, the method comprising:
causing display of potential gifts on a first electronic communications device of a party giving a gift, the first electronic communications device configured for wireless communication;
receiving from the first electronic communications device information that identifies a gift selected from the potential gifts;
receiving from the first electronic communications device information that identifies a recipient, the recipient being a person to receive the selected gift;
receiving from the first electronic communications device information that defines parameters for message delivery to a second electronic communications device of the recipient; and
sending a message containing a code to the second electronic communications device, the sending performed using the parameters for message delivery, the code uniquely associated with the selected gift, the code redeemable for only the selected gift, the code formatted to be recognized and processed by a specific retailer of the selected gift.

2. The method of claim 1, wherein the information that identifies the recipient includes contact information of the recipient.

3. The method of claim 1, wherein the parameters for message delivery are selected from the group consisting of a name of the person to receive the selected gift, a time for sending the message, and a graphic depiction of the selected gift.

4. The method of claim 1, further comprising uniquely associating the code with both the selected gift and the specific retailer in such a way to prevent the code from being redeemed at a retailer different from the specific retailer and to prevent the code from being redeemed for a product or service different from the specific gift.

5. The method of claim 1, further comprising:
receiving from the first electronic communications device a greeting from the party giving the gift to the recipient, the greeting customized to the recipient; and
sending the greeting with the message to the second electronic communications device.

6. The method of claim 1, further comprising:
presenting the code to the specific retailer; and
receiving the gift only when the specific retailer validates the presented code, wherein the presenting step and the receiving step are performed by the recipient.

7. A method of giving a specific gift of a product or service, the method comprising:
receiving information identifying a gift and identifying a recipient, the recipient being a person to receive the gift, the information being received from a first electronic communications device of a party giving the gift; and
sending a code to a second electronic communications device of the recipient, the code uniquely associated with the gift, the code redeemable for only the gift at a specific retailer of the gift, the code formatted to be recognized and processed by the specific retailer, the sending performed by a computer system in response the information received from the first electronic communications device.

8. The method of claim 7, wherein the first electronic communications device and the second electronic communications device are configured for wireless communication, and the receiving of the information and the sending of the code are performed through at least one wireless carrier.

9. The method of claim 7, wherein the information received from the first electronic communications device includes a mobile telephone number of the second electronic communications device.

10. The method of claim 7, wherein the information received from the first electronic communications device includes routing data to route a message regarding the gift over an electronic network to the recipient, the routing data selected from the group consisting of a wireless telephone number, an e-mail address, an account on a social networking website, and a server address.

11. The method of claim 7, further comprising using the first electronic communications device to identify the gift through a website of the specific retailer, the website accessed by the first electronic communications device.

12. The method of claim 7, further comprising entering a message string into the first electronic communications device to identify the gift and the recipient.

13. The method of claim 7, wherein the sending step includes communicating the code through a wireless carrier to the second electronic communications device as a message via Short Message Service or via Multimedia Messaging Service.

14. The method of claim 7, further comprising, before the step of receiving information identifying the gift and identifying the recipient:
receiving a search term from the first electronic communications device, the search term received through a wireless carrier; and
communicating through the wireless carrier information about a plurality of possible gifts satisfying the search term.

15. The method of claim 7, further comprising recognizing the code as valid and activated, the recognizing step performed by a point-of-sale system of the specific retailer, the point-of-sale system in communication with the computer system.

16. The method of claim 7, wherein the code is a gift card number, and the method further comprises:
funding the gift card number with a monetary balance equivalent to a price recognized by the specific retailer for the gift, the funding electronically performed after the information identifying the gift and identifying the recipient is received from the first electronic communications device or upon the sending of the gift code to the second electronic device; and
processing redemption of the gift card number using a point-of-sale system, the processing performed without communicating with the computer system, the processing including zeroing the monetary balance of the gift card number.

17. The method of claim 7, wherein the code is a coupon code that provides for a price discount by the specific retailer to the recipient, the price discount predetermined by the party giving the gift, the price discount being from 0% to 100% of a price recognized by the specific retailer for the gift, and the method further comprises:
using a point-of-sale system of the specific retailer to cancel the coupon code.

18. The method of claim 7, wherein the code correlates to a purchasing account with the specific retailer, the purchasing account owned by the party giving the gift.

19. The method of claim 7, further comprising:
communicating accept/decline information to a point-of-sale system of the specific retailer, the communicating performed by the computer system in response to a query received by the computer system from the point-of-sale system, the query based on presentation of the code by the recipient to the specific retailer.

20. The method of claim 19, wherein the presentation of the code is performed by the recipient according to a process selected from the group consisting of: verbally reading the code; allowing a representation of the code to be rendered on the second electronic communications device and allowing the point-of-sale system to scan the rendered representation; and allowing wireless transmission of the code from the second electronic communications device to the point-of-sale system.

21. The method of claim 7, wherein the code comprises a first code portion and a second code portion, the first code portion and second code portion are located separately from each other on a gift card, the first code portion embedded within a payment processing system of the gift card, the second code portion being visible on a gift card.

22. The method of claim 21, further comprising allowing the recipient to obtain the gift from the specific retailer only when the first code portion and the second code portion are combined.

23. The method of claim 7, wherein:
the code comprises a first code portion and a second code portion;
the first code portion is uniquely associated the gift, is sent to the second communications device, and is provided to a retail point-of-sale system; and
the second code portion is associated with the recipient, and the second code portion is provided to retail point-of-sale system by action of the recipient; and
the first and second code portions are combined to form a single code that uniquely identifies a gift transaction defined at least in part by identity of the gift, identity of the retailer, identity of the recipient, and identity the sender; and
the first and second code portions must be received by the retail point-of-sale system and validated by either the retail point-of-sale system or the computer system to allow the recipient to receive the gift from the retailer.

24. The method of claim 23, wherein the computer system communicates the first and second code portions at one time to the retailer point-of-sale system, or the computer system combines the first and second code portion to form the single code and communicates the single code to retailer point-of-sale system.

25. The method of claim 7, further comprising:
sending to an account on a social networking website a communication about the gift, the account owned by the recipient, the sending performed by the computer system using an application programming interface (“API”) of the social networking website.

26. A system for giving gifts of a specific product of service, comprising:
a computer system in communication with an electronic communications device and a second electronic communications device, the computer system receives from the first electronic communications device gift information identifying a specific gift and recipient information identifying a person to receive the specific gift, the computer system comprises a database system that uses the gift information to generate or retrieve a code uniquely associated with the specific gift, a retailer management system that customizes format of the code for a specific retailer of the specific gift, and a user management system that uses the recipient information to send the formatted code to the second electronic communications device,
wherein the computer system uniquely associates the code with the specific gift from the specific retailer in such a way to prevent the code from being redeemed at a retailer different from the specific retailer and to prevent the code from being redeemed for a product or service different from the specific gift.

27. The system of claim 26, wherein the computer system is in communication with a point-of-sale system of the specific retailer, the computer system sends confirmation of validity of the code to the point-of-sale system in response to a query from the point-of-sale system, and the computer system invalidates or deactivates the code in response to communication from the point-of-sale system indicating redemption of the code for the specific gift.
